(19) United States
(12) Patent Application Publication
(10) Pub. No.: US 2026/0036433 A1
(43) Pub. Date: Feb. 5, 2026

(54) APPARATUS AND METHOD FOR PROVIDING STRATEGIES FOR CHARGING VEHICLES

(71) Applicant: HERE GLOBAL B.V., EINDHOVEN (NL)

(72) Inventors: JEROME BEAUREPAIRE, COURBEVOIE (FR); AMARNATH NAYAK, MUMBAI (IN)

(73) Assignee: HERE GLOBAL B.V., EINDHOVEN (NL)

(21) Appl. No.: 18/792,614

(22) Filed: Aug. 2, 2024

(51) Int. Cl. G01C 21/34; G01C 21/36

(52) U.S. Cl. CPC G01C 21/3492; G01C 21/343; G01C 21/3446; G01C 21/3469; G01C 21/3484; G01C 21/3635

(57) ABSTRACT

An apparatus, a method, and a non-transitory computer-readable storage medium for providing strategies for charging vehicles is provided. For example, the apparatus obtains, using a map database, traffic congestion information on a road segment, predicts a traffic congestion status on the road segment based on the traffic congestion information, generates an objective function based on the traffic congestion status, computes a solution of the objective function using an integer programming or a linear programming, generates a recommendation based on the solution, and outputs the recommendation.

### TECHNOLOGICAL FIELD

The present disclosure generally relates to providing strategies for charging electric vehicles, and more specifically relates to an apparatus and a method for generating recommendation of strategies for charging electric vehicles.

### BACKGROUND

With advancements in the field of automobile engineering, electric vehicles (EVs) have gained popularity as an alternative to conventional internal combustion engines. EVs may be advantageous over conventional internal combustion engines due to certain benefits, such as reduced carbon emissions, high energy efficiency, low operating cost, and improved performance. However, electrical energy stored in the EVs gradually decreases during operation of the EVs. The EVs may consume the electrical energy to power the electric motors during the operation of the EVs. In addition to powering the electric motors, the EVs may consume the electrical energy to power other onboard systems. The onboard systems may include, but are not limited to, heating systems, air conditioning systems, ventilation systems, air purification systems, infotainment systems, and the like that are integrated within EV to enhance user experience. Additionally, the onboard systems may consume the electrical energy while the EVs are stationary leading to a continuous battery drain in the EVs. The continuous battery drain in the EVs may reduce driving ranges of the EVs. The driving range of an EV may refer to a distance that the EV can travel on a single battery charge or on a current battery level. Hence, to maintain a desirable driving range and optimal driving performance, there is a need for periodically charging the EVs.

However, there are various challenges associated with charging the EVs. For example, accessibility of charging points may be limited due to various real time factors such as high demand during peak hours, charging point maintenance, limited parking space, traffic, and the like. Additionally, various real time factors may lead to variability in the driving ranges of the EVs. Other real time factors may include, but are not limited to, weather conditions, road conditions, driving behaviors, special events, and road congestion. For example, extreme temperatures significantly impact the performance and efficiency of the battery. In cold weather, batteries of the EVs may experience decreased efficiency and capacity, leading to a reduced driving range, while in hot weather, excessive heat may accelerate battery degradation. In another example, aggressive driving, frequent acceleration, braking, and high-speed driving may significantly reduce efficiency and reduce the driving range of the EVs. The variability in the driving range of the EVs may increase challenges in determining an actual range of the EVs for the current battery level of the EVs. Moreover, the continuous battery drains in the EVs and the variability in the actual range of the EVs may lead to a range anxiety of users of the EVs. For example, being stuck in the traffic with the continuous battery drain in the EVs and an uncertainty about the actual driving range of the EVs may lead to a range anxiety of the users of the EVs.

Therefore, there is a need for providing strategies for charging electric vehicles to overcome the aforementioned challenges.

### BRIEF SUMMARY OF SOME EXAMPLE EMBODIMENTS

An apparatus, a method, and a computer programmable product are provided for implementing the process for recommendation of strategies for charging electric vehicles.

In one aspect, an apparatus for recommendation of strategies for charging electric vehicles is disclosed. The apparatus includes at least one processor and at least one non-transitory memory including computer program code instructions, the computer program code instructions configured to, when executed, cause the apparatus to, obtain, using a map database, traffic congestion information on a road segment, predict a traffic congestion status on the road segment based on the traffic congestion information, and generate an objective function based on the traffic congestion status. The computer program code instructions are configured to, when executed, cause the apparatus to compute a solution of the objective function using an integer programming or a linear programming, generate a recommendation based on the solution, and output the recommendation.

In additional apparatus embodiments, the objective function corresponds to maximization in a duration for charging the vehicle, and the recommendation is associated with the duration.

In additional apparatus embodiments, the objective function is subjected to a set of constraints. The set of constraints includes at least one of a travel time constraint, a charging point distance constraint, a charging point availability constraint, and an elapsed time constraint.

In additional apparatus embodiments, the recommendation is a first recommendation. The computer program code instructions are configured to, when executed, cause the apparatus to receive a user input associated with a selection of an optimization parameter among a set of optimization parameters. The set of optimization parameters includes a first optimization parameter associated with a delay in navigation towards a charging point, a second optimization parameter associated with an availability of the charging point, or a combination thereof. The computer program code instructions are configured to, when executed, cause the apparatus to generate a second objective function based on the user input. The second objective function is associated with the optimization parameter. The computer program code instructions are configured to, when executed, cause the apparatus to generate a second recommendation for charging the vehicle based on a solution of the second objective function. The computer program code instructions are configured to, when executed, cause the apparatus to output the second recommendation.

In additional apparatus embodiments, each optimization parameter of the set of optimization parameters is associated with a set of constraints. The set of constraints is associated with at least one of a delay constraint and a charging point distance constraint.

In additional apparatus embodiments, the user input is associated with a selection of the first optimization parameter. The objective function corresponds to a minimization of the delay in the navigation towards the charging point.

In additional apparatus embodiments, the user input is associated with a selection of the second optimization parameter. The objective function corresponds to an assurance of the availability of the charging point.

In additional apparatus embodiments, the computer program code instructions are configured to, when executed, cause the apparatus to extract a set of features based on the road segment and the traffic congestion information. The computer program code instructions are configured to, when executed, cause the apparatus to apply a first machine learning (ML) model on the extracted set of features. The computer program code instructions are configured to, when executed, cause the apparatus to predict the traffic congestion status on the road segment based on the application of the first ML model on the extracted first set of features.

In additional apparatus embodiments, the set of features is associated with a functional class of the road segment, a cause of traffic congestion on the road segment, a delay in an estimated time of arrival of the vehicle, a timestamp, or a combination thereof.

In additional apparatus embodiments, the traffic congestion status indicates a duration of a traffic congestion on the road segment.

In additional apparatus embodiments, the recommendation indicates a duration for charging the vehicle at a charging point.

In additional apparatus embodiments, the computer program code instructions are configured to, when executed, cause the apparatus to determine a need for an electric vehicle charging unit (EVCU) at a location proximate to the road segment based on the traffic congestion information, one or more geographical attributes of the location, one or more weather conditions associated with the location, or a combination thereof. The EVCU is equipped with a power supply configured to charge the vehicle. The computer program code instructions are configured to, when executed, cause the apparatus to transmit a request for the EVCU at the location in response to the need satisfying a threshold.

In additional apparatus embodiments, the computer program code instructions are configured to, when executed, cause the apparatus to output the recommendation on a user interface associated with the vehicle, causing the vehicle to control at least one vehicle-related function based on the recommendation, or a combination thereof.

In another aspect, a method for providing strategies for charging electric vehicles is disclosed. The method includes obtaining, using a map database, traffic congestion information on a road segment. The method further includes predicting a traffic congestion status on the road segment based on the traffic congestion information. The method further includes obtaining one or more attributes associated with a set of charging points. The one or more attributes includes one or more road attributes associated with the set of charging points. The method further includes generating, based on the one or more attributes and the predicted traffic congestion status, a recommendation for charging a vehicle at a charging point among the set of charging points. The method further includes outputting the recommendation.

In additional method embodiments, the recommendation includes routing instructions to navigate towards the first charging point.

In additional method embodiments, the method includes generating an objective function based on the one or more attributes and the traffic congestion status. The objective function corresponds to a minimization of a waiting time at the charging point. The method further includes computing a solution of the objective function using an integer programming or a linear programming. The method further includes generating the recommendation based on the solution.

In additional method embodiments, the one or more road attributes indicates one or more functional classes of one or more road segments associated with the set of charging points. The objective function is subjected to at least one constraint. The at least one constraint is the one or more functional classes.

In additional method embodiments, the first objective function is further subjected to a set of constraints. The set of constraints includes at least one of a charging point availability constraint, an elapsed time constraint, a power compatibility constraint, and a temperature constraint.

In additional method embodiments, the method includes outputting the recommendation on a user interface associated with the vehicle, causing the vehicle to control at least one vehicle-related function based on the recommendation, or a combination thereof.

In yet another aspect, a non-transitory computer-readable storage medium having computer program code instructions stored therein, the computer program code instructions, when executed by at least one processor, cause the at least one processor to obtain vehicle route to a destination. The computer program code instructions, when executed by at least one processor, cause the at least one processor to obtain a set of parameters including road segment parameters indicating one or more road attributes of one or more road segments of the route. The computer program code instructions, when executed by at least one processor, cause the at least one processor to cause a machine learning (ML) model to output a prediction indicative of a vehicle traversing the route to reach the destination as a function of the set of parameters. The computer program code instructions, when executed by at least one processor, cause the at least one processor to generate a recommendation for charging the vehicle based on the prediction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment for providing strategies for charging vehicles, in accordance with an embodiment of the disclosure;

FIG. 2 illustrates a block diagram of the apparatus of FIG. 1, in accordance with an embodiment of the disclosure;

FIG. 3 is a block diagram that illustrates an exemplary first set of operations for providing strategies for charging electric vehicles, in accordance with an embodiment of the disclosure;

FIG. 4 is a block diagram that illustrates an exemplary second set of operations for providing strategies for charging electric vehicles, in accordance with an embodiment of the disclosure;

FIG. 5 is a block diagram that illustrates training of the ML model for prediction of the traffic congestion status on a road segment, in accordance with an embodiment of the disclosure.

FIG. 6 is a block diagram that illustrates an exemplary third set of operations for recommendation of strategies for charging electric vehicles, in accordance with an embodiment of the disclosure;

FIG. 7 is a diagram that depicts an exemplary scenario for determining reduced driving ranges of electric vehicles, in accordance with an embodiment of the disclosure.

FIG. 8A is a diagram that illustrates a first exemplary scenario of rendering recommendations on a user interface, in accordance with an embodiment of the disclosure.

FIG. 8B is a diagram that illustrates a second exemplary scenario of rendering recommendations on a user interface, in accordance with an embodiment of the disclosure.

FIG. 8C is a diagram that illustrates a third exemplary scenario of rendering recommendations on a user interface, in accordance with an embodiment of the disclosure.

FIG. 9 is a diagram that depicts an exemplary scenario for charging electric vehicle with electric vehicle charging unit (EVCU), in accordance with an embodiment of the disclosure;

FIG. 10 is a flowchart that illustrates a first exemplary method of providing a recommendation for charging an electric vehicle, in accordance with an embodiment of the disclosure;

FIG. 11 is a flowchart that illustrates a second exemplary method of providing a recommendation for charging an electric vehicle, in accordance with an embodiment of the disclosure; and

FIG. 12 is a flowchart that illustrates a third exemplary method providing a recommendation for charging an electric vehicle, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

To further elaborate on the challenges associated with charging electric vehicles, optimal strategy for charging electric vehicles may not be readily apparent to users of the electric vehicles. For example, an electric vehicle may be stuck in traffic on a highway, and a user of the vehicle may be aware that the user's vehicle is continuously draining battery while the vehicle is barely moving on the highway. Hence, the user may be motivated to charge his/her vehicle at a nearby charging point since staying idle in the traffic will continuously drain the vehicle's electric power supply and may potentially render the vehicle unable to reach its designated destination due to the vehicle's limited power supply. To take advantage of the user's current situation, the user may render a detour from the user's current trip to charge the user's electric vehicle at a nearby charging point. In such scenario, the user may use a mobile device or the vehicle's infotainment system to access an application that enables the user to locate a nearby charging point and determine the charging point's availability. However, such conventional technology limits the user from determining the most optimal strategy for charging the user's electric vehicle because said technology is typically limited to providing real-time data (e.g., current traffic condition and current availability of a charging point), and the user is still required to combine all data available to the user through said technology to determine an optimal window of time for charging the user's electric vehicle at the charging point. Since the user's situation may evolve over time, the effectiveness of the user's strategy for charging the electric vehicle may also change over time. For example, the traffic of the highway may clear up by the time the electric vehicle reaches the charging point, thereby increasing the overall duration of the user's trip for reaching the user's original destination. By way of another example, the charging point may be unavailable when the user arrives at the location of the charging point, thereby increasing the overall duration of the user's trip.

Therefore, there is a need for providing an effective strategy for charging an electric vehicle to overcome the aforementioned challenges.

The present disclosure may provide an apparatus, a method, and a computer programmable product for providing strategies for charging vehicles. The disclosed apparatus and the method provide techniques for generating a recommendation for charging a vehicle travelling on a road segment. The recommendation may indicate a duration for charging the vehicle at a charging point based on real-time parameters such as traffic, charge point availability, and the like. In an embodiment, the recommendation may be determined based on a traffic congestion status on the road segment. The techniques disclosed in the present disclosure may use a machine learning model to predict the traffic congestion status on the road segment. The ML model may predict the traffic congestion status on the road segment based on traffic congestion information. The traffic congestion information may be associated with traffic congestion on the road segment.

Additionally, or alternatively, the techniques used in the present disclosure may generate the recommendation based on the traffic congestion status of traffic at the road segment. The recommendation may be generated by solving an objective function. In an embodiment, the objective function may correspond to a maximization in the duration for charging the vehicle. In an embodiment, the objective function may be generated based on the traffic congestion status. A solution of the objective function may be computed using an integer programming or a linear programming. In an embodiment, an optimization model may employ at least one of the integer programming or the linear programming to compute the first solution of the objective function. Further, the apparatus may be configured to generate the recommendation associated with the duration based on the computed solution of the objective function. The recommendation may be rendered on an infotainment unit of the vehicle to assist the user of the vehicle in determining a need to charge the vehicle, thereby mitigating the range anxiety.

The disclosed apparatus may further communicate with a map database to update the traffic congestion status to generate the recommendation associated with the duration for charging the vehicle. The disclosed apparatus and method may be able to predict a near-accurate driving range of electric vehicles based on the traffic congestion status. Specifically, the disclosed apparatus may compute the driving range while travelling on the road segment. This may ensure that the driving range is close to the desired driving range of the vehicle. Moreover, the disclosed apparatus and method may be configured to alert the user of the vehicle about the recommendation, using visual and/or audio alerts. This way, the user may be aware of the recommendation. The disclosed apparatus may communicate with a cruise control system of the vehicle to automatically navigate on the road segment based on the recommendation.

The recommendation allows for mitigation of the aforementioned challenges associated with charging the vehicles. For example, the recommendation may allow a user of the vehicle to determine whether it is advantageous to stay on the road segment in the traffic or to charge the vehicle at the charging point, thereby reducing range anxiety and enhancing the user's trip. In an embodiment, the recommendation may indicate the user to stay on the road segment if a traffic congestion status indicates an increase in the traffic (e.g., by 20 percent) at the road segment over a period (e.g., 30 minutes). In another embodiment, if the traffic congestion status indicates the traffic at the road segment is decreasing or is stagnant, the recommendation may indicate the user to charge the vehicle at the charging point.

In some scenarios, the recommendation may also indicate the user to leave the traffic based on a determination that charging station is located proximate to the vehicle, and the user can drive to the charging station for the charging the vehicle. The recommendation may indicate the user to stay on the road segment based on a determination that a nearest charging station requires significant detour. Additionally, the charging time of the vehicle may be variable based on a type of charger used for charging the vehicle and the battery capacity of the vehicle. The type of charger may include, but is not limited to, a slow charger, a fast charger, and a rapid charger. The recommendation may allow the user of the vehicle to determine whether to leave the traffic or not based on an amount of time that the user wants to utilize charging.

The apparatus may utilize the current battery level of the vehicle to generate the recommendation. In an example, if a current battery level of the vehicle is low, then the recommendation may indicate the user to leave the traffic for charging the vehicle. In another embodiment, if the current battery level of vehicle is relatively full and is estimated to outlast the traffic congestion at the road segment, the recommendation may indicate the user to stay in the traffic.

The recommendation further enhances driving experience of the vehicle by optimizing route planning for the vehicle. For example, the recommendation may eliminate a need for a user to manually search for a charging point or assess traffic conditions at a road segment.

In an embodiment, the apparatus may determine the recommendation based on the destination of the vehicle. In an example embodiment, based on a determination that the vehicle is unable to reach the destination with the current battery level, the recommendation may indicate the user to leave the traffic and charge the vehicle at the charging point. In another example embodiment, based on a determination that the vehicle may reach the destination with the current battery level of the vehicle, the recommendation may indicate the user to stay in the traffic as leaving the traffic may result in a delay for reaching the destination.

In an embodiment, the apparatus may determine the recommendation based on a real time traffic conditions on the road segment and an availability of alternate routes to reach the charging point. In an example embodiment, the apparatus may generate a recommendation indicating the user of the vehicle to stay in a traffic of a current route if the apparatus determines that the vehicle will be stuck in a traffic of another route from a location on the current route to the charging point.

In an embodiment, the recommendation may include an efficient route plan to charge the vehicle at the charging point. In an embodiment, the apparatus may further determine the efficient route plan based on real time traffic conditions and locations of charging points. The efficient route plans may allow for a minimization of total travel time of the vehicle and avoidance of detours or unnecessary stops.

The recommendation may further enhance a security for the user of the vehicle by providing alerts for charging the vehicle before a complete depletion of the battery of the vehicle. The alerts allow prevention of situations where the vehicle may run out of power in potentially unsafe or inconvenient locations, for example, highways or remote areas.

To provide efficient energy management, the recommendation may be generated based on the current state of the battery of the vehicle, driving patterns associated with the user of the vehicle, and energy consumption. The recommendation may lead to a less stressful environment for the user while the user drives the vehicle at the road segment, leading to a wider adoption of electric vehicles and sustainable environmental goals.

The disclosed apparatus may be configured to iteratively collect data associated with at least one of driving behaviors, user preferences (such as charging habits, and a schedule) common driving routes and update the recommendation. The updated recommendation further generates personalized recommendation for the user of the vehicle. Furthermore, the collected data can be utilized to expand charging infrastructure and to optimize battery technology.

A feature of the recommendation associated with the charging of the vehicle may provide competitive advantages in the EV market. The feature of providing the recommendation may be a deciding factor for potential buyers who are concerned about range anxiety and practicalities of driving the EVs. The feature of the recommendation associated with the charging of the vehicle may be integrated with other features, such as recommending nearby charging stations that offer discounts or additional services. This allows companies to create opportunities for cross-selling and up-selling. Providing the recommendation in stressful situations can positively impact a brand's image. Further, demonstrating a commitment to customer care and innovation enhances the company's reputation, potentially attracting new customers and retaining existing ones for the EVs.

Specifically, the disclosed apparatus may facilitate a user of an electric vehicle to decide, when the electric vehicle is in a traffic congestion and the battery of the vehicle is low, whether it is more efficient to charge at a nearby charging point or stay in the traffic congestion based on contextual information related to traffic, charging point availability, the current range of the vehicle, the destination of the vehicle, and the like.

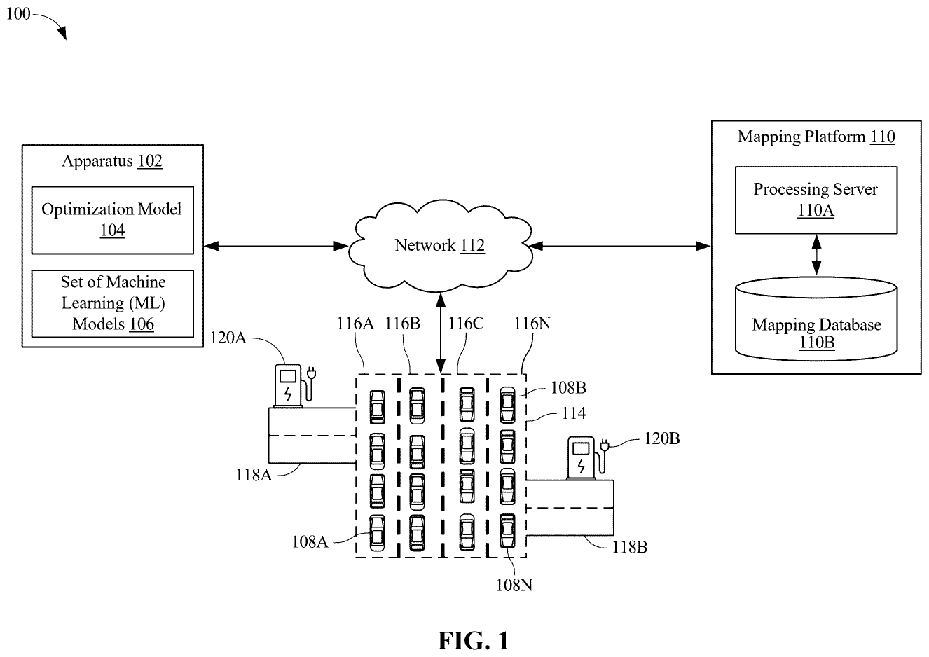

FIG. 1 is a diagram that illustrates a network environment 100 for providing strategies for charging electric vehicles, in accordance with an embodiment of the disclosure. With reference to FIG. 1, there is shown a diagram of the network environment 100. The network environment 100 includes an apparatus 102, an optimization model 104, a set of machine learning (ML) models 106, a set of vehicles 108A, 108B, and up to 106N, a mapping platform 110. The network environment 100 may further include a network 112. With reference to FIG. 1, the network environment 100 further includes a road segment 114, a set of link segments 118A and 118B, and a set of charging points 120A and 120B. The set of vehicles 108A, 108B, and up to 106N may be travelling on the road segment 114 and may include a first vehicle 108A, a second vehicle 108B, up to an Nth vehicle 106N. The mapping platform 110 may include a processing server 110A and a map database 110B.

In an embodiment, the road segment 114 may include a set of lane segments 116A, 116B, 116C, and up to 116N. The set of lane segments 116A, 116B, 116C, and up to 116N may include a first lane segment 116A, a second lane segment 116B, a third lane segment 116C, and up to an Nth Lane segment 116N. The set of link segments 118A and 118B may be associated with the road segment 114. The set of link segments 118A and 118B may include a first link segment 118A, and a second link segment 118B. The set of charging points 120A and 120B may be situated proximate to the set of link segments 118A and 118B, respectively. The set of charging points 120A and 120B may include a first charging point 120A and a second charging point 120B. In an embodiment, the first charging point 120A and the second charging point 120B may be points-of-interest (POIs) that are connected to the first link segment 118A and the second link segment 118B, respectively. In an embodiment, the set of charging points 120A and 120B may be situated proximate to the road segment 114. In an embodiment, the apparatus 102 may be associated with the first vehicle 108A. In another embodiment, the apparatus 102 may be integrated with the first vehicle 108A.

The apparatus 102 may include suitable logic, circuitry, interfaces, and/or code that may be configured to generate the recommendation for charging the first vehicle 108A. Specifically, the apparatus 102 may be configured to generate the recommendation for charging the first vehicle 108A. In an embodiment, the apparatus 102 may be configured to obtain traffic congestion information on the road segment 114 from the map database 110B. The obtained traffic congestion information may be indicative of traffic on the road segment 114. Based on the obtained traffic congestion information, the apparatus 102 may be configured to predict the traffic congestion status. In an embodiment, the predicted traffic congestion status may indicate a predicted volume of traffic on the road segment 114. The predicted volume of traffic may indicate a number of vehicles travelling on the road segment 114 over a period of time (such as 5 minutes, 10 minutes, and the like). Thereafter, the apparatus 102 may be configured to generate the recommendation based on the traffic congestion status indicating a change in traffic at the road segment 114. Examples of the apparatus 102 may include, but are not limited to, an electronic control unit (ECU) of the first vehicle 108A, an electronic control module (ECM) of the first vehicle 108A, a computing device, a mainframe machine, a server, a computer workstation, any and/or any other device with vehicle charging recommendation operations.

In an example embodiment, the apparatus 102 may be on-boarded by the first vehicle 108A. For example, the apparatus 102 may be a charging recommendation system installed in the first vehicle 108A for generating a recommendation associated with a duration for charging the first vehicle 108A at the first charging point 120A. In another example embodiment, the apparatus 102 may be the processing server 110A of the mapping platform 110 and may be co-located with or within the mapping platform 110.

In another embodiment, the apparatus 102 may be embodied as a cloud-based service, a cloud-based application, a cloud-based platform, a remote server-based service, a remote server-based application, a remote server-based platform, or a virtual computing system. In yet another example embodiment, the apparatus 102 may be an OEM (Original Equipment Manufacturer) cloud. In an embodiment, the OEM cloud may be configured to anonymize any data received or outputted by the apparatus 102, such traffic congestion information and data used by the set of ML models 106 or the map database 110B. In an embodiment, anonymization of data may be performed by the mapping platform 110.

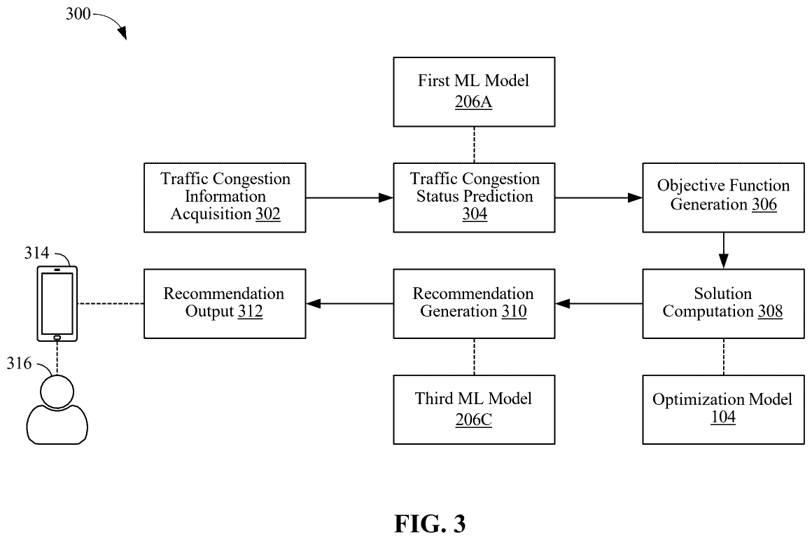

The optimization model 104 may correspond to a mathematical framework of a decision problem that objective is to determine an optimal solution of the decision problem among a set of feasible solutions subjected to a set of constraints. Generally, the decision problem may include, but is not limited to, a resource allocation problem, a scheduling problem, a routing problem, and a charging management problem. In an example embodiment, the charging management problem may include, but are not limited to, a maximization in a duration for charging the first vehicle 108A with a limitation on an increase of a total travel of the first vehicle 108A with respect to the destination of the first vehicle 108A. Details about the solution of the charging management problem are provided, for example, in FIG. 3. The optimization model 104 may be utilized in a plurality of fields (such as engineering, economics, logistics, operations research, or the like) to maximize or minimize an objective function while satisfying the set of constraints. The objective function may correspond to a mathematical expression that includes a plurality of variables of the decision problem. The plurality of variables of the decision problem may be updated iteratively to determine the optimal solution among the set of feasible solutions. The set of constraints may correspond to limitations associated with the decision variables of the decision problem. The set of constraints may define a feasible region to determine the optimal solution of the decision problem. The set of constraints may include equality constraints and inequality constraints. The optimization model 104 may employ various optimization techniques to determine the optimal solution of the decision problem within the feasible region. Various optimization techniques may include, but are not limited to, the linear programming, the integer programming, the non-linear programming, and a dynamic programming.

The linear programming is an optimization technique that may be employed to determine the optimal solution of the decision problem by optimizing a linear objective function subjected to a linear set of constraints. The linear set of constraints may include linear equality constraints and linear inequality constraints. The linear programming may be employed to maximize or minimize the linear objective function while satisfying the linear set of constraints. The integer programming is a type of the linear programming that includes at least one decision variable limited to be an integer. The integer programming is an optimization technique that may be employed to solve decision problems such as branch and bound problems, cutting plane problems, and heuristics problems. The non-linear programming is an optimization technique that may be employed to solve the decision problems that include at least one of non-linear objective function or a non-linear set of constraints. The dynamic programming is an optimization technique that may be employed to solve the decision problem by decomposing the decision problem into smaller sub problems. In the dynamic programming, each sub problem may be solved iteratively. Further, in the dynamic programming, a solution of sub problems may be stored to avoid redundant computations, thereby reducing the computation cost in solving the decision problem.

The set of ML models 106 may be trained to identify a relationship between inputs, such as a set of features in a training dataset, and output predictive values. The set of ML models 106 may be defined by its hyper-parameters, for example, a number of weights, cost function, input size, number of layers, and the like. The hyper-parameters of the set of ML models 106 may be tuned and weights may be updated to move towards a global minima of a cost function for the corresponding ML model. After several epochs of the training on the feature information in the training dataset, the set of ML models 106 may be trained to output a recommendation for a set of inputs. The recommendation may be indicative of a duration for charging the first vehicle 108A at the first charging point 120A.

Each of the set of ML models 106 may include electronic data, such as, for example, a software program, code of the software program, libraries, applications, scripts, or other logic or instructions for execution by a processing device, such as the apparatus 102. The set of ML models 106 may include code and routines configured to enable a computing device, such as the apparatus 102 to perform one or more operations for predicting traffic congestion status on the road segment 114 and determining recommendations for charging the first vehicle 108A. Specifically, the set of ML models 106 may be trained to output a predicted traffic congestion status. Additionally, or alternatively, the set of ML models 106 may be implemented using hardware including a processor, a microprocessor (e.g., to perform or control the performance of one or more operations), a field-programmable gate array (FPGA), or an application-specific integrated circuit (ASIC). Alternatively, in some embodiments, the set of ML models 106 may be implemented using a combination of hardware and software. Examples of the set of ML models 106 may include, but are not limited to, a Deep Neural Network (DNN), an Artificial Neural Network (ANN), a Convolutional Neural Network (CNN), or combination thereof.

Each vehicle of the set of vehicles 108A, 108B, and up to 108N may be a non-autonomous vehicle, a semi-autonomous vehicle, or a fully autonomous vehicle, for example, as defined by National Highway Traffic Safety Administration (NHTSA). Examples of each vehicle of the set of vehicles 108A, 108B, and up to 108N may include, but are not limited to, a two-wheeler vehicle, a three-wheeler vehicle, a four-wheeler vehicle, more than a four-wheeler vehicle, a hybrid vehicle, or a vehicle with autonomous drive capability that uses one or more distinct renewable or non-renewable power sources. The vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Each vehicle of the set of vehicles 108A, 108B, and up to 108N may be a system through which an occupant (for example a rider) may travel from a start point to a destination point. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell-based car, a solar powered-car, or a hybrid car. It may be noted here that the four-wheeler diagram of each of the set of vehicles 108A, 108B, and up to 108N are merely shown as examples in FIG. 1. The present disclosure may also be applicable to other structures, designs, or shapes of each of the set of vehicles 108A, 108B, and up to 108N. The description of other types of vehicles and respective structures, designs, or shapes has been omitted from the disclosure for the sake of brevity.

In some example embodiments, each vehicle of the set of vehicles 108A, 108B, and up to 108N may include processing means such as a central processing unit (CPU), storage means such as on-board read-only memory (ROM), random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of each vehicle of the set of vehicles 108A, 108B, and up to 108N. In some example embodiments, a user equipment may be associated, coupled, or otherwise integrated with the set of vehicles 108A, 108B, and up to 108N, such as an advanced driver assistance system (ADAS), a personal navigation device (PND), a portable navigation device, and/or other devices that may be configured to provide route guidance and navigation-related functions to the user.

In some example embodiment, the first vehicle 108A may generate sensor data associated with a battery level of the first vehicle 108A. In accordance with an embodiment, the sensor data may be generated by the first vehicle 108A, when one or more sensors on-board the first vehicle 108A may sense information relating to, for example, the battery level of the first vehicle 108A being less than a first battery level. In an embodiment, the first battery level may be determined based on a user input received from the user of the first vehicle 108A. In another embodiment, the first battery level may be determined based on a destination of the first vehicle 108A. In an exemplary embodiment, the first battery level may be set to 50%, 40%, and the like. In accordance with an embodiment, the first vehicle 108A may generate the sensor data in real-time and transmit it to the apparatus 102 to determine the recommendation for charging the first vehicle 108A. In certain cases, the first vehicle 108A may be configured to send updated sensor data periodically, for example, every five seconds, every thirty seconds, every minute, and so forth.

For example, the user equipment may be installed in the first vehicle 108A and may be configured to detect sensor data by using sensors installed in the corresponding vehicle. The user equipment may transmit the detected sensor data to the apparatus 102, which processes the detected data for determining the recommendation for charging the first vehicle 108A.

In an embodiment, each vehicle of the set of vehicles 108A, 108B, and up to 108N may include an infotainment system. The infotainment system may include suitable logic, circuitry, interfaces and/or code that may be configured to render at least audio-based data, or video-based data, on the user interface in the corresponding vehicle of the set of vehicles 108A, 108B, and up to 108N. For example, the infotainment system may include a display to display the user interface on which the video-based data may be displayed. In another example, the infotainment system may include a plurality of speakers to output the audio-based data. In such an example, the audio-based data may include, but is not limited to, audio content rendered on the plurality of speakers communicatively coupled to the user interface. The infotainment system may be configured to render the recommendation for charging the first vehicle 108A on the user interface. Examples of the infotainment system may include, but are not limited to, an entertainment system, a navigation system, a vehicle user interface system, an Internet-enabled communication system, and other entertainment systems.

The mapping platform 110 may comprise suitable logic, circuitry, and interfaces that may be configured to store one or more map attributes and sensor data associated with traffic on the set of lane segments 116, 116B, 116C, and up to 116N and/or the set of link segments 118 and 118B. The mapping platform 110 may be configured to store and update map data indicating the traffic data along with other map attributes, road attributes, and traffic entities, in the map database 110B. The mapping platform 110 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 110 may be collected using a plurality of technologies including, but not limited to drones, sensors, connected cars, cameras, probes, and chipsets. In some embodiments, the mapping platform 110 may be embodied as a chip or chip set. In other words, the mapping platform 110 may comprise one or more physical packages (such as chips) that include materials, components, and/or wires on a structural assembly (such as a baseboard).

In some example embodiments, the mapping platform 110 may include the processing server 110A for carrying out the processing functions associated with the mapping platform 110 and the map database 110B for storing map data. In an embodiment, the processing server 110A may include one or more processors configured to process requests received from the apparatus 102. The processors may fetch sensor data and/or map data from the map database 110B and transmit the same to the apparatus 102 in a format suitable for use by the apparatus 102.

Continuing further, the map database 110B may comprise suitable logic, circuitry, and interfaces that may be configured to store the sensor data and map data, which may be collected from the first vehicle 108A. In an embodiment, the first vehicle 108A may be traveling on the first lane segment 116A of the road segment 114, or in a region close to the first lane segment 116A. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 110 or the map database 110B of features within an environment that is appropriate for traffic-related services. In accordance with an embodiment, the sensor data may be collected from any sensor that may inform the mapping platform 110 or the map database 110B of features within an environment that is appropriate for mapping. For example, motion sensors, inertia sensors, image capture sensors, proximity sensors, LiDAR sensors, and ultrasonic sensors may be used to collect the sensor data. The gathering of massive quantities of crowd-sourced data may facilitate the accurate modeling and mapping of an environment, whether it is a road link or a link within a structure, such as in an interior of a multi-level parking structure.

The map database 110B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 110B may be configured to receive the map data including the road topology and geometry-related attributes related to the road network from external systems, such as one or more of background batch data services, streaming data services, and third-party service providers, via the network 112.

In accordance with an embodiment, the map data stored in the map database 110B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 110B may further store historical probe data for events (such as, but not limited to, traffic incidents, construction activities, scheduled events, and unscheduled events) associated with Point of Interest (POI) data records or other records of the map database 110B.

For example, the data stored in the map database 110B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 110B in a delivery format to produce one or more compiled navigation databases.

In some embodiments, the map database 110B may be a master geographic database configured on the side of the apparatus 102. In accordance with an embodiment, the map database 110B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the first vehicle 108A) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 110B.

For an example, the map database 110B may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 110B may additionally include data about places, such as cities, towns, or other communities, and other geographic features such as, but not limited to, bodies of water, and mountain ranges.

In some example embodiments, images received from the image source may be stored within the map database 110B of the mapping platform 110. In certain cases, the mapping platform 110, using the processing server 110A, may suitably process the received images. For example, such processing may include, suitably labeling the images based on corresponding associated lane and/or link, point of interest within the link and/or lane, and other information relating to the respective link and/or lane. Such labeled images may then be stored within the map database 110B as map data.

The network 112 may be wired, wireless, or any combination of wired and wireless communication networks, such as cellular, Wi-Fi, internet, local area networks, or the like. In some embodiments, the network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, international telecommunication union (ITU), international mobile communications (IMT) networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The embodiments disclosed herein address the aforementioned problems related to the charging of the first vehicle 108A when the first vehicle 108A is being driven on the road segment 114. In an embodiment, the battery level of the first vehicle 108A may decrease in the traffic congestion on the road segment 114. In an embodiment, the battery level of the first vehicle 108A may decrease in the traffic congestion on the road segment 114 due to the consumption of electrical energy by the electric motor, and the onboard systems associated with the first vehicle 108A. The onboard systems may include, but are not limited to, heating systems, air conditioning systems, ventilation systems, air purification systems, and infotainment systems.

In operation, the user of the first vehicle 108A may be planning to navigate from a first location (e.g., the user's starting location) to a second location (e.g., the user's destination) using the first vehicle 108A. However, the continuous usage of the vehicle's battery reduces the driving range of the first vehicle 108A. The driving range of the first vehicle 108A may refer to a distance that the first vehicle 108A may travel on a given battery charge. Additionally, or alternatively, various real time factors (such as traffic condition on the road segment 114, weather conditions on the road segment 114, and driving behavior of a user of the first vehicle 108A) may lead to variability in the driving range of the first vehicle 108A. The variability in the driving range of the first vehicle 108A may increase challenges in the determination of an actual range of the first vehicle 108A based on a current battery level of the first vehicle 108A. Moreover, the continuous drainage of the battery in the first vehicle 108A and the variability in an actual range of the first vehicle 108A may lead to a range anxiety in the user of the first vehicle 108A. In order to overcome challenges associated with the charging of the first vehicle 108A, the apparatus 102 may be configured to generate the recommendation for charging the first vehicle 108A. The first recommendation may indicate a charging point and a duration for charging the first vehicle 108A at the corresponding charging point to overcome the driving range and range anxiety issues. Additionally, the recommendation may include routing instructions to navigate towards the first charging point 120A. Based on the generation of the recommendation, the apparatus 102 may be configured to cause the first vehicle 108A to control at least one vehicle-related function. The at least one vehicle related function may include, but is not limited to, a navigation function, a speed control function, a collision avoidance function, and a vehicle diagnostics function.

In an embodiment, the apparatus 102 may be configured to obtain the traffic congestion information on the road segment 114 from the mapping database 110B. Based on the obtained traffic congestion status, the apparatus 102 may be configured to predict the traffic congestion status on the road segment 114. The apparatus 102 may be configured to generate a recommendation plan based on the traffic congestion status indicative of a change in the traffic at the road segment 114. For example, the apparatus 102 may be configured to generate a recommendation plan indicating that the first vehicle 108A should stay in a traffic of the road segment 114 if the traffic congestion status indicates that the traffic is predicted to increase (e.g., by 20%) over a period (e.g., 30 minutes). By way another example, the apparatus 102 may configured to generate a recommendation plan indicating that a user of the first vehicle 108A should charge the first vehicle 108A at a charging point proximate to the road segment 114 if the traffic congestion status indicates that a traffic of the road segment 114 is predicted to stay the same or decrease over a period.

The apparatus 102 may be configured to output the generated recommendation. In an embodiment, the apparatus 102 may be configured to output the recommendation on a user interface associated with the first vehicle 108A. In another embodiment, the apparatus 102 may be configured to generate a virtual object that may be indicative of the generated recommendation and output the generated virtual object on the user interface the infotainment system associated with the first vehicle 108A. In another embodiment, the apparatus 102 may be configured to render an audio output indicative of the recommendation. Details about the output of the recommendation are provided, for example, in FIGS. 3, 4, and 7.

In an embodiment, the apparatus 102 may be communicatively coupled to each vehicle of the set of vehicles 108A, 108B, and up to 108N, and the mapping platform 110, via the network 112. In an embodiment, the apparatus 102 may be communicatively coupled to other components not shown in FIG. 1 via the network 112. All the components in the network environment 100 may be coupled directly or indirectly to the network 112. The components described in the network environment 100 may be further broken down into more than one component and/or combined together in any suitable arrangement. Further, one or more components may be rearranged, changed, added, and/or removed.

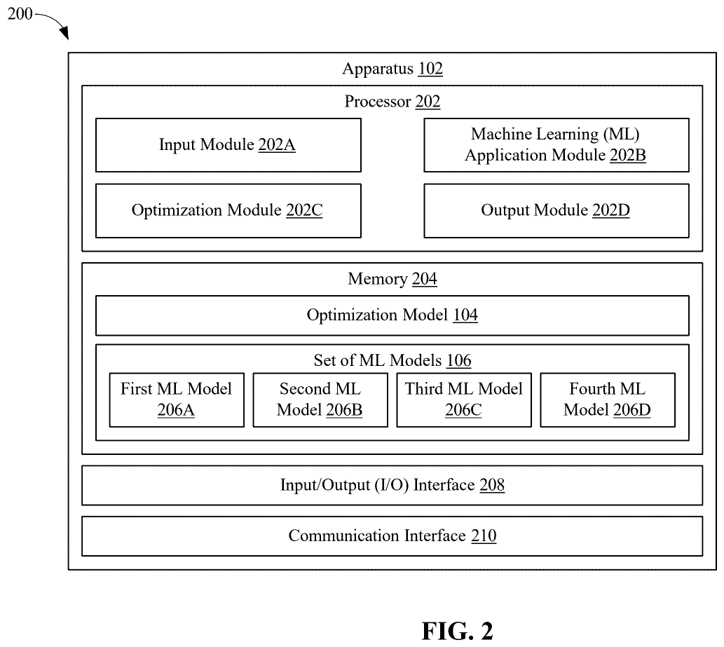

FIG. 2 illustrates a block diagram 200 of the apparatus of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor 202 (referred to as a processor 202, hereinafter), at least one non-transitory memory 204 (referred to as a memory 204, hereinafter), an input/output (I/O) interface 208, and a communication interface 210. The processor 202 may comprise modules, depicted as, an input module 202A, an ML application module 202B, an optimization module 202C, and an output module 202D. The apparatus 102 may be connected to the memory 204, and the I/O interface 208 through wired or wireless connections. Although in FIG. 2, it is shown that the apparatus 102 includes the processor 202, the memory 204, and the I/O interface 208, the disclosure may not be so limiting, and the apparatus 102 may include fewer or more components to perform the same or other functions of the apparatus 102. In an embodiment, the input module 202A, and the output module 202D may be integrated within the I/O interface 208. In some embodiments, the input module 202A may receive input data (such as user inputs), and the output module 202D may output processed data (such as the predicted traffic congestion status, the generated recommendation, the virtual object, and the like) via the I/O interface 208.

In accordance with an embodiment, the apparatus 102 may store data that may be generated by the modules while performing corresponding operations or may be retrieved from a database associated with the apparatus 102, such as the map database 110B, in the memory 204. For example, the data may include vehicle information, traffic information, user information, distance information, and environmental information.

The processor 202 of the apparatus 102 may be configured to generate the recommendation for charging the first vehicle 108A and output the generated recommendation. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

In an example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment 100 may be accessed using the communication interface 210 of the apparatus 102. The communication interface 210 may provide an interface for accessing various features and data stored in the apparatus 102.

In some embodiments, the processor 202 may be configured to provide Internet-of-Things (IOT) related capabilities to users of the apparatus 102 disclosed herein. The IoT-related capabilities may in turn be used to provide smart city solutions by providing the recommendation associated with charging the first vehicle 108A, real-time warnings, big data analysis, and sensor-based data collection by using the cloud-based mapping system for providing accurate navigation instructions and ensuring driver safety. The I/O interface 208 may provide an interface for accessing various features and data stored in the apparatus 102.

The input module 202A of the processor 202 may be configured to obtain the traffic congestion information on the road segment 114. In an embodiment, the traffic congestion information may be obtained from the map database 110B. In an alternate embodiment, the traffic congestion information may be obtained from the one or more sensors. In an embodiment, the one or more sensors may be associated with at least the first vehicle 108A of the set of vehicles 108. In another example, the one or more sensors may be installed in the vicinity of the set of lane segments and may be configured to obtain the sensor data that may include the traffic congestion information. For example, the one or more sensors may include one or more image sensors, one or more LIDARs, one or more speed sensors, one or more global positioning sensors (GPS), and the like.

The ML application module 202B of the processor 202 may be configured to apply a first ML model 206A of the set of ML models 106 on extracted set of features. The extracted set of features may be associated with the at least one of a functional class of the road segment 114, a cause of the traffic congestion on the road segment 114, a delay in an estimated time arrival of the first vehicle 108A, a timestamp, or a combination thereof. The first ML model 206A may be trained to predict the traffic congestion status on the road segment 114. Details about the first ML model 206A are provided, for example, in FIG. 3.

In an embodiment, the processor 202 may be configured to extract the set of features based on the road segment 114 and the obtained traffic congestion information. In an embodiment, the set of ML models 106 may include a first ML model 206A that may be trained to predict the traffic congestion status on the road segment 114. In an embodiment, the ML application module 202B of the processor 202 may be configured to predict the traffic congestion status on the road segment 114 based on the application of the first ML model 206A on the extracted set of features.

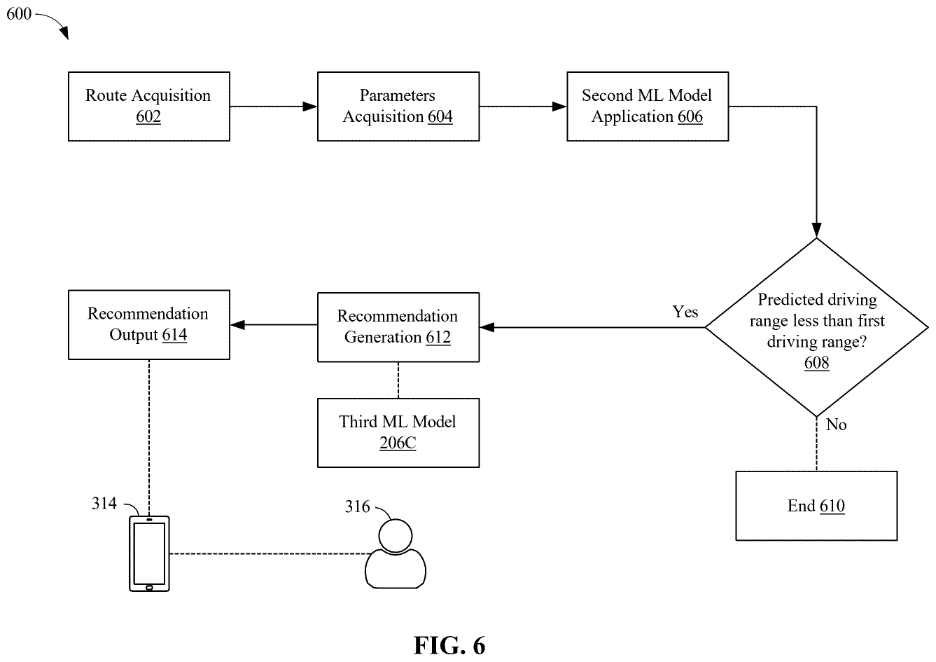

In another embodiment, the set of ML models 106 may include a second ML model 206B that may be trained to predict whether the first vehicle 108A will reach the destination or not with the remaining vehicle range associated with the first vehicle 108A. In an embodiment, the ML application module 202B of the processor 202 may be configured to predict whether the first vehicle 108A will reach the destination or not with the remaining vehicle range associated with the first vehicle 108A based on the application of the second ML model 206B on the traffic congestion status and the current battery charge level associated with the first vehicle 108A. Details about the second ML model 206B are provided, for example, in FIG. 6.

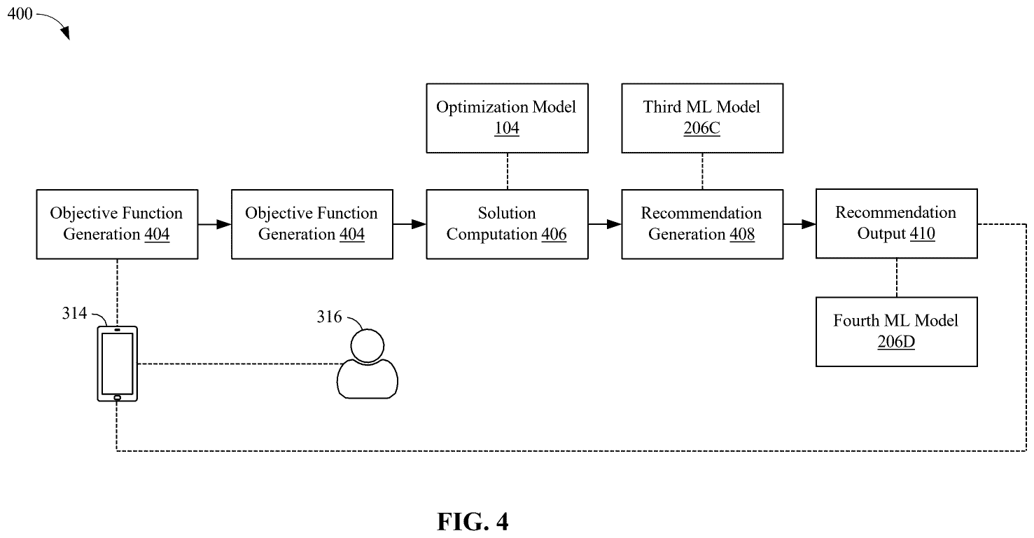

In yet another embodiment, the set of ML models 106 may include a third ML model 206C that may be trained to evaluate the recommendation for charging the first vehicle 108A based on data indicating real outcome of an event in which the recommendation was provided to the user of the first vehicle 108A. In an embodiment, the third ML model 206C may be configured to execute the computer program code instruction that may cause the apparatus 102 to output the recommendation on the user interface associated with the first vehicle 108A. Details about the third ML model 206C are provided, for example, in FIG. 3 and FIG. 4.

In an additional embodiment, the set of ML models 106 may include a fourth ML model 206D that may be trained to determine an acceptance probability associated with a selection of a recommendation by the user of the first vehicle 108A. The acceptance probability corresponds to a probability of selection the first recommendation by the user of the first vehicle 108A. The acceptance probability may indicate whether the user of the first vehicle 108A will select the generated recommendation or not. Details about the fourth ML model 206D are provided, for example, in FIG. 4.

The optimization module 202C of the processor 202 may be configured to compute a solution of the objective function. In an embodiment, the optimization module of the processor 202 may be configured to compute the solution of objective function based on the traffic congestion status. In an embodiment, the optimization module 202C may employ the integer programming or the linear programming to compute the solution of the objective function. Details about the computation of the solution of the objective function using the optimization model 104 are provided, for example, in FIG. 3.

The output module 202D of the processor 202 may be configured to output the predicted traffic congestion status and/or the generated recommendation. In an embodiment, the output module 202D may be configured to generate one or more virtual objects indicating the predicted traffic congestion, the generated recommendation, or a combination thereof. In another embodiment, the output module 202D may be configured to alert the user about the generated recommendation. The output module 202D may be further configured to output the generated one or more virtual objects and the audio alerts on the I/O interface 208 of the apparatus 102. In another embodiment, the output module 202D of the processor 202 may be configured to transmit the at least one of the predicted traffic congestion status and the generated recommendation to the map database 110B. In another embodiment, the output module 202D of the processor 202 may be configured to control the maneuver of the first vehicle 108A to maintain the driving range of the first vehicle 108A.

Although the illustrated embodiment depicts the input module 202A, the ML application module 202B, the optimization module 202C, and the output module 202D as components of the processor 202, the disclosure may not be so limiting. In certain embodiments, the input module 202A, the ML application module 202B, the optimization module 202C, and the output module 202D may be software components embodied within the memory 204, and said software components may be executed by the processor 202 to perform their corresponding functions.

The memory 204 of the apparatus 102 may be configured to store the traffic congestion information, the traffic congestion status, and the recommendation. The memory 204 of the apparatus 102 may be configured to store a route of the first vehicle 108A, a user command associated the at least one vehicle-related function, and the virtual object. In an embodiment, the memory 204 may be configured to store the optimization model 104, and the set of ML models 106. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured as hardware for conducting the operations described herein.

In some example embodiments, the I/O interface 208 may communicate with the apparatus 102 and display the input and/or output of the apparatus 102. As such, the I/O interface 208 may include a display and, in some embodiments, may also include a keyboard, a mouse, a joystick, a touch screen, touch areas, soft keys, one or more microphones, a plurality of speakers, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or I/O interface 208 circuitry comprising the processor 202 may be configured to control one or more functions of one or more I/O interface 208 elements through computer program instructions (for example, software and/or firmware) stored on a memory 204 accessible to the processor 202. The processor 202 may further render notifications associated with the navigation instructions, such as traffic data, traffic conditions, traffic congestion value, ETA, routing information, road conditions, driving instructions, etc., on the user equipment or audio or display onboard the vehicles via the I/O interface 208.

The communication interface 210 may comprise an input interface and output interface for supporting communications to and from the apparatus 102 or any other component with which the apparatus 102 may communicate. The communication interface 210 may be any means such as a device or circuitry embodied in either hardware or a combination of hardware and software that is configured to receive and/or transmit data to/from a communications device in communication with the apparatus 102. In this regard, the communication interface 210 may include, for example, an antenna (or multiple antennae) and supporting hardware and/or software for enabling communications with a wireless communication network. Additionally, or alternatively, the communication interface 210 may include the circuitry for interacting with the antenna(s) to cause transmission of signals via the antenna(s) or to handle receipt of signals received via the antenna(s). In some environments, the communication interface 210 may alternatively or additionally support wired communication. As such, for example, the communication interface 210 may include a communication modem and/or other hardware and/or software for supporting communication via cable, digital subscriber line (DSL), universal serial bus (USB), or other mechanisms. In some embodiments, the communication interface 210 may enable communication with a cloud-based network to enable deep learning, such as using the set of ML models 106 (that may be hosted on the cloud-based network).

FIG. 3 is a block diagram 300 that illustrates an exemplary first set of operations for providing strategies for charging electric vehicles, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 312, as described herein. The exemplary operations illustrated in the block diagram 300 may start at 302 and may be performed by any computing system, apparatus, or device, such as by the apparatus 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the particular implementation.

In an embodiment, the user 316 of the first vehicle 108A may be planning to navigate from the first location (e.g., a starting location of the user 316) to the second location (e.g., a destination of the user 316) using the first vehicle 108A. The exemplary operations from 302 to 312 may be executed as soon as an ignition of the first vehicle 108A may be turned on or the first vehicle 108A starts moving. In another embodiment, the exemplary operations from 302 to 312 may be executed based on a reception of the user input from the user 316 of the first vehicle 108A via an input device. In another embodiment, the exemplary operations from 302-312 may be executed based on the environment of the first vehicle 108A or the state of the first vehicle 108A. For example, the exemplary operations from 302-312 may be executed if the first vehicle 108A slows down in a highway, the first vehicle 108A drives below a predetermined speed at a highway, the first vehicle 108A enters an area with a predetermined amount of traffic congestion, or a combination thereof.

At 302, a traffic congestion information acquisition operation may be executed. In the traffic congestion information acquisition operation, the apparatus 102 may be configured to obtain the traffic congestion information. The traffic congestion information may be associated with the traffic on the road segment 114. Specifically, the input module 202A of the processor 202 may be configured to obtain the traffic congestion information on the road segment 114. In an embodiment, the apparatus 102 may be configured to obtain the traffic congestion information that may be stored in the map database 110B. In an embodiment, the apparatus 102 may be configured to obtain the traffic congestion information based on the reception of the user input indicating recommendation of the electric vehicle charging points (or EVCPs) or the start of the ignition of the first vehicle 108A. In another embodiment, the apparatus 102 may be configured to obtain the traffic congestion information automatically without reception of any user input. In yet another embodiment, the apparatus 102 may be configured to obtain the traffic congestion information in response to a battery level of the first vehicle 108A being less than a predetermined battery level. In an embodiment, the traffic congestion information may include at least an average speed of the set of vehicle 108A, 108B, and up to 108N travelling on the road segment 114, and a number of vehicles on each lane segment of the set of lane segments.

At 304, a traffic congestion status prediction operation may be executed. In the traffic congestion status prediction operation, the apparatus 102 may be configured to predict the traffic congestion status on the road segment 114. In an embodiment, the apparatus 102 may be configured to predict the traffic congestion status based on the obtained traffic congestion information. In an embodiment, the traffic congestion status may be indicative of at least one of enqueuing of the traffic congestion on the road segment 114, dequeuing of the traffic congestion on the road segment 114, stagnant traffic congestion on the road segment 114, or a combination thereof over a period. In another embodiment, the traffic congestion status may indicate at least one of enqueuing of the traffic congestion on the first lane segment 116A, dequeuing of the traffic congestion on the first lane segment 116A, or stagnant traffic congestion on the first lane segment 116A.

In an embodiment, the enqueuing of the traffic congestion on the road segment 114 may be indicative of increase in the traffic at the corresponding location on the road segment 114 or the set of lane segments. In an embodiment, one or more reasons behind the enqueuing of the traffic congestion on the road segment 114 may include, but is not limited to high traffic volume, bottlenecks, accidents, road closures, inefficient traffic flow management, or a combination thereof. In an embodiment, the dequeuing of the traffic congestion on the road segment 114 may be indicative of a decrease in the traffic at the corresponding location on the road segment 114 or the set of lane segments. In an embodiment, the stagnant traffic congestion on the road segment 114 may be indicative of a stationary volume of the traffic at the corresponding location on the road segment 114 or the set of lane segments.

In an embodiment, the apparatus 102 may be configured to extract the set of features or road attributes associated with the road segment 114 to predict the traffic congestion status. The extracted set of features or road attributes may be associated with the at least one of a functional class of the road segment 114, a cause of the traffic congestion on the road segment 114, a delay in an estimated time arrival of the first vehicle 108A, a timestamp, event data, or a combination thereof. In an embodiment, the processor 202 may be configured to extract the set of features or road attributes based on the road segment 114 and the obtained traffic congestion information.

The functional class associated with the road segment 114 may correspond to a road type indicator that may reflect a traffic speed and a traffic volume, as well as the importance and connectivity of the road segment 114. The functional class of the road segment 114 may be a numerical value ranging from 1 to 5. For example, the functional class “1” may indicate a road with a high-volume traffic, and a maximum-speed traffic. The functional class “2” may indicate a road with a high volume, and a high-speed traffic. The functional class “3” may indicate a road with a high-volume traffic. The functional class “4” may indicate a road with a high-volume traffic at moderate speeds between neighborhoods and the functional class “5” may indicate a road whose volume and traffic flow may be below the level of any other functional class. In an example embodiment, the cause of the traffic congestion corresponds to an accident on the road segment 114. In an example embodiment, a delay in the estimated time arrival may correspond to 5 minutes, 10 minutes, or 20 minutes. In an example embodiment, the timestamp may correspond to an hour of a day (such as 8:00 Ante Meridiem (A.M), 1:00 Post Meridiem (P.M), 10:30 P.M). In an embodiment, the processor 202 may be configured to extract the set of features based on real time traffic conditions associated with the road segment 114. The event data may include, but is not limited to, a holiday (such as Christmas, New Year, and the like), a day before the holiday, and a day after the holiday.

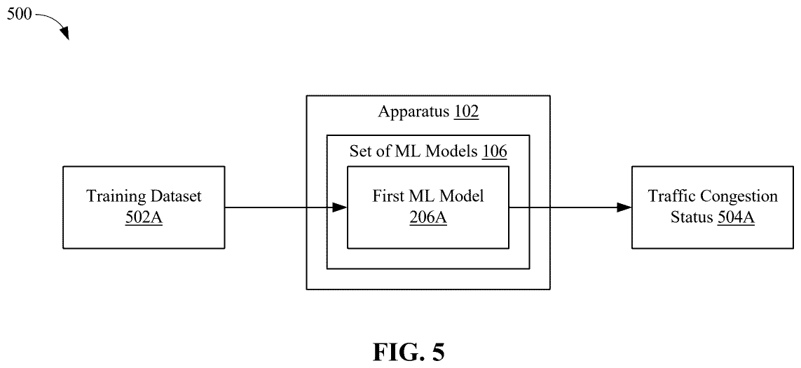

The apparatus 102 may be configured to apply the first ML model 206A on the extracted set of features. Thereafter, the apparatus 102 may be configured to predict the traffic congestion status on the road segment 114 based on the application of the first ML model 206A on the extracted set of features. Specifically, the ML application module 202B of the processor 202 may be configured to predict the traffic congestion status on the road segment 114 based on the application of the first ML model 206A on the extracted set of features. As discussed above, the first ML model may be a pre-trained machine learning model that may be trained on the extracted set of features to output the traffic congestion status. In an embodiment, the first ML model 206A may correspond to a regression model. The regression model may be configured to predict a target value (such as the traffic congestion status) based on input variables (such as the extracted set of features). The regression model may be configured to predict the traffic congestion status based on a relationship between the target value and the input variables. The predicted traffic congestion status may be indicative of a duration of traffic congestion on the road segment 114. Details about training the first ML model 206A are provided, for example, in FIG. 5.

In an embodiment, the processor 202 may be configured to iteratively extract the set of features based on real time traffic conditions on the road segment 114. In an embodiment, the processor 202 may be configured to obtain real time information associated with the cause of the congestion from traffic cameras associated with the road segment 114. Further, based on the media data (such as images, video, or audio) associated with traffic cameras, the apparatus 102 may be configured to determine the cause of the congestion. In an embodiment, the apparatus 102 may be configured to obtain the media data iteratively to detect the cause of the congestion or the absence of the cause of congestion. In an embodiment, the apparatus 102 may be configured to process, using an image processing model, the media data to detect the cause of the traffic congestion. In another embodiment, the processor 202 may be configured to obtain the real time information associated with the cause of the congestion from cameras associated with the first vehicle 108A. In an embodiment, the apparatus 102 may be configured to iteratively update the recommendation based on the iterative extraction of the set of features corresponding to the real time traffic conditions on the road segment 114.

At 306, an objective function generation operation may be executed. In the objective function generation operation, the apparatus 102 may be configured to generate the objective function based on the predicted traffic congestion status. In an embodiment, apparatus 102 may be configured to generate an objective function if the traffic congestion status indicates that the traffic congestion on the road segment 114 is dequeuing or stagnant. In an embodiment, apparatus 102 may be configured to generate an objective function if the traffic congestion status indicates that the traffic congestion on the road segment 114 is predicted dequeue, remain stagnant for a period, or a combination thereof.

In an embodiment, the objective function may be generated to correspond to maximization in a duration for charging the first vehicle 108A at a charging point (e.g., the first charging point 120A). The objective function may be generated to maximize an optimal duration for charging of the first vehicle 108A at a charging point. In an embodiment, the objective function may be generated to maximize the duration for charging the first vehicle 108A if the charging point is the only charging point within a predetermined distance or travel time from the current location of the first vehicle 108A (e.g., 3 km or 1 percent of the total travel time of the first vehicle 101A). In such embodiment, the objective function may be subjected to a set of constraints. The set of constraints may correspond to limitations associated with decision variables of the objective function (such as travel time of the first vehicle 108A, a distance of the charging point from the first vehicle 108A, and the like). The set of constraints may include at least one of a travel time constraint, a charging point distance constraint, a charging point availability constraint, an elapsed time constraint, a delay time constraint, and an exit constraint.

In an embodiment, the travel time constraint may correspond to a limitation on an increase in the total travel time of the first vehicle 108A from the first location to the second location. In an embodiment, to satisfy the travel time constraint, the increase in total travel time of the first vehicle 108A from the first location to the second location must be limited to a threshold time period such as 10 minutes, 20 minutes, and the like. In another embodiment, to satisfy the travel time constraint, the increase in the total travel time of the first vehicle 108A from the first location to the second location must be limited to a percentage of the total travel time of the first vehicle 108A, such as 10 percent of the total travel time of the first vehicle 108A. Specifically and by way of example, the travel time constraint may indicate that the travel time of the first vehicle 108A must not be increased by Δt (where Δt can be 10% of the total travel time or the threshold time period).

The charging point distance constraint may be associated with a distance between a location of the first vehicle 108A and a location of the charging point. In an embodiment, the charging point distance constraint may correspond to a limitation of the distance between the location of the first vehicle 108A and the location of the charging point to be recommended to the user 316 of the first vehicle 108A for charging the first vehicle 108A. In an embodiment, to satisfy the charging point distance constraint, the distance between the location of the first vehicle 108A and the charging point must be limited to a distance threshold such as 10 meters, 20 meters, 1 mile, 3 miles, and the like. In another embodiment, to satisfy the charging point distance constraint, the distance between the location of the first vehicle 108A and the charging point must be limited to a percentage of the total travel time of the first vehicle 108A, such as 1 percent of the total travel time of the first vehicle 108A. Specifically and by way of example, the charging point distance constraint may indicate that the distance “D” to the charging point must not be greater than “X” mile(s) where “X” can be 1% of the total travel time or a predetermined distance (e.g., 3 miles).

The charging point availability constraint may be associated with the availability of the set of charging points. In an embodiment, the charging point availability constraint may correspond to a limitation on a probability of availability of the charging point of the set of charging points. In an embodiment, to satisfy the charging point availability constraint, the probability of availability of the charging point must be greater than a predetermined probability value. In an embodiment, the predetermined probability value may be for example, 0.8, or 0.9. Specifically, the charging point availability constraint may indicate that the EVCP availability must be greater than “p” probability where “p”=0.8.

The elapsed time constraint may be associated with an elapsed charging time of a vehicle charging at a charging point. The elapsed charging time is the amount of time that elapsed while the vehicle charges at the charging point. In an embodiment, the elapsed time constraint may correspond to a limitation of the elapsed charging time of the vehicle charging at the charging point. In an embodiment, to satisfy the elapsed time constraint, the elapsed charging time of the vehicle must be greater than a predetermined amount of charging time, such as 30 minutes.

The delay time constraint may be associated with a delay time of the first vehicle 108A with respect to an anticipated arrival time of the first vehicle 108A at the second location. In an embodiment, the delay time constraint may correspond to a limitation of an increase in the delay time of the first vehicle 108A with respect to the anticipated arrival time at the second location (e.g., due to the first vehicle 108A making a detour at a charging station). In an embodiment, to satisfy the delay time constraint, the increase in the delay time of the first vehicle 108A with respect to the anticipated arrival time of the first vehicle 108A at the second location must be limited to a threshold time period such as 30 minutes, 35 minutes, and the like. Specifically, and by way of example, the delay time constraint may indicate that the delay time “X” with respect to the second location must not be greater than “X” minutes, where “X” is 30.

The exit constraint may be associated with a distance between the location of the first vehicle 108A and a node associated with a current road or link segment on which the first vehicle 108A is located. In an embodiment, the node may be an exit for a highway. In an embodiment, the node may be the closest node relative to the location of the first vehicle 108A. In an embodiment, the node may be directly connected to the current road or link segment on which the first vehicle 108A is located. In an embodiment, the exit constraint may correspond to a limitation of the distance between the location of the first vehicle 108A and the node (e.g., a node connecting the road segment 114 and the first link segment 118A). In an embodiment, to satisfy the exit constraint, the distance between the location of the first vehicle 108A and the node must be limited to a distance threshold, such as 100 meters, 150 meters, 1 mile, or the like. By way of example, the exit constraint may indicate that the distance between the first vehicle 108A and the node must not be greater than “D” meters, where “D” may be 100.

In an embodiment, if the apparatus 102 determines that there a set of multiple charging points within the predetermined distance or travel time from the current location of the first vehicle 108A, the objective function may be generated to correspond to minimization in waiting time. In such embodiment, the waiting time may indicate time spent on being idle in traffic, time spent on slowly moving in traffic (e.g., less than 10 km/h), time spent on waiting for a charging point to be available for use, time spent on waiting for the first vehicle 108A to charge (but no less than the total amount of charging time needed for the first vehicle 108A to reach its designated destination), or a combination thereof. In such embodiment, the objective function may be subjected to a set of constraints. The set of constraints may include at least one of the charging point availability constraint, the elapsed time constraint, a functional class constraint, a power compatibility constraint, a temperature constraint, or a combination thereof.

The functional class constraint may be associated with a functional class (FC) of a functional class of a road segment associated with a charging point. Herein, a road segment associated with a charging point indicates: (1) a road segment that is within a predetermined distance from the charging point (e.g., within 100 meters); (2) a road segment that is directly connected to an entrance/exit roadway of a point of interest that includes the charging point; (3) a road segment that is the closest to the charging point; or (3) a combination thereof. In an embodiment, the functional class constraint may correspond to a limitation of the functional class of a segment associated with a charging point. In an embodiment, to satisfy the functional class constraint, a functional class of a road segment associated with a charging point must correspond to the functional class 4 or the functional class 5.

The power compatibility constraint may be associated with compatibility of a vehicle charger and a charging point. In an embodiment, to satisfy the power compatibility constraint, a vehicle charger must be compatible with a charging point.

The temperature constraint may be associated with an environment around a charging point, the first vehicle 108A, or a combination thereof. In an embodiment, to satisfy the temperature constraint, the temperature of the environment around a charging point, the first vehicle 108A, or a combination thereof must be limited to a first temperature range. The first temperature range may be expressed in various units of temperature such as Celsius, Fahrenheit, and Kelvin. Specifically, and by way of example, the temperature constraint may indicate that the first temperature range “−t to +t” where t=−35 Celsius, and t=35 Celsius.

At 308, a solution computation operation may be executed. In the solution computation operation, the apparatus 102 may be configured to compute a solution of the objective function that corresponds to the maximization in the duration for charging the first vehicle 108A. Specifically, the optimization module 202C of the processor 202 may be configured to compute the solution of the objective function using the optimization model 104. The optimization model 104 may employ at least one of the integer programming or the linear programming to compute the solution of the objective function. In an embodiment, the optimization model 104 may employ the linear programming or the integer programming to maximize the duration for charging the first vehicle 108A at the charging point.

In an embodiment, the computed solution of the objective function may include the duration for charging the first vehicle 108A at the charging point. In an embodiment, the computed solution of the objective function may further include an initial charging time indicative of an initiation of charging the first vehicle 108A at the charging point, and a charging completion time indicative of a completion of the charging at the charging point.

In an embodiment in which the set of multiple charging points is identified, the apparatus 102 may be configured to compute a solution of the objective function that corresponds to the minimization in waiting time and select a charging point among the set of multiple charging points based on the solution. For example, the selected charging point among the set of multiple charging points may enable the user of the first vehicle 108A to traverse to the selected charging point, charge the first vehicle 108A at the selected charging point, and traverse to the destination of the first vehicle 108A while experiencing minimum waiting time.

At 310, a recommendation generation operation may be executed. In the recommendation generation operation, the apparatus 102 may be configured to generate a recommendation based on the computed solution of the objective function. In an embodiment, the recommendation may include, but are not limited to, a location of a charging point, a distance of the charging point from the current location of the first vehicle 108A, the duration for charging the first vehicle 108A at the charging point, the initial charging time and the charging completion time. By way of an example and not limitation, the recommendation may indicate “charge the vehicle at a charging point ‘A’ for 30 minutes to reach your destination due to current traffic conditions”.

In an embodiment, the third ML model 206C may be configured to determine a performance score based on a real outcome of an event in which the recommendation provided to the user 316 of the first vehicle 108A. Data indicating the real outcome may indicate, for example, a duration for which the first vehicle 108A was charged at the charging point, the availability of the charging point when the first vehicle 108A arrived at the charging point, the total travel time of the first vehicle 108A, etc. By way of example, if data indicating the real outcome indicate that: (1) the first vehicle 108A was charged at the charging point for the duration as indicated in the recommendation; and (2) the increase in the total travel time of the first vehicle 108A from the first location to the second location was less than 10 percent of the total travel time, the third ML model 206C may output a high performance score, and apparatus 102 may continue to generate recommendations for users without any fine tuning. Conversely, if data indicating the real outcome indicate that: (1) the first vehicle 108A was not charged at the charging point for the duration as indicated in the recommendation; or (2) the increase in the total travel time of the first vehicle 108A from the first location to the second location was more than 10 percent of the total travel time, the third ML model 206C may output a low performance score, and the apparatus 102 may fine tune processes for outputting recommendations for users (e.g., by altering one or more of the set of constraints, altering algorithm or programming used for generating recommendations, etc.).

At 312, a recommendation output operation may be executed. In the recommendation output operation, the apparatus 102 may be configured to output the recommendation. Specifically, the output module 202D of the processor 202 may be configured to output the recommendation. In an embodiment, the output of the recommendation may correspond to the rendering of the recommendation on the user interface of the first vehicle 108A or a user device 314 associated with the user 316 of the first vehicle 108A.

In another embodiment, the output of the recommendation may correspond to the rendering of the recommendation on a user device 314 associated with a user 316 of the first vehicle 108A. In an embodiment, the user device 314 may be a client device, such as a thin client device, a mobile device, a mainframe computer, a desktop computer and the like. In an embodiment, the processor 202 may be configured to provide the generated recommendation as an option for selection by the user 316. In an embodiment, the recommendation may be displayed on a display screen associated with the infotainment system or the user device 314 (such as a mobile phone). In another example, the user 316 may be notified by using an audio signal, thereby rendering the recommendation via a set of speakers associated with the infotainment system or the user device 314.

In an embodiment, the apparatus 102 may be configured to receive a user input indicative of a selection of the recommendation for charging the first vehicle 108A by the user 316 of the first vehicle 108A. In an embodiment, the apparatus 102 may be configured to determine an amount of time saved by the user 316 of the first vehicle 108A based on the selection of the recommendation for charging the first vehicle 108A during congestion on the road segment 114.

In an embodiment, the apparatus 102 may be configured to receive a user input from the user 316 of the first vehicle 108A. Based on the received user input, the apparatus 102 may select optimization parameters associated with the navigation of the first vehicle 108A with respect to the second location. Further, the apparatus 102 may be configured to optimize the selected optimization parameters to enhance the driving experience of the user 316. Details about the optimization parameters are provided, for example, in FIG. 4.

FIG. 4 is a block diagram 400 that illustrates an exemplary second set of operations for providing strategies for charging electric vehicles, in accordance with an embodiment of the disclosure. FIG. 4 is explained in conjunction with elements from FIGS. 1, 2, and 3. With reference to FIG. 4, there is shown the block diagram 400 that illustrates exemplary operations from 402 to 410, as described herein. The exemplary operations illustrated in the block diagram 400 may start at 402 and may be performed by any computing system, apparatus, or device, such as by the apparatus 102 of FIG. 1 or the processor 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a user input retrieval operation may be executed. In the user input retrieval operation, the apparatus 102 may be configured to receive a user input associated with a selection of an optimization parameter among a set of optimization parameters. In an embodiment, the set of optimization parameters may include a first optimization parameter that may be associated with a delay in navigation from a first location (e.g., a starting location of the user 316) to a second location (e.g., a destination of the user 316). In another embodiment, the set of optimization parameters may include a second optimization parameter that may be associated with the availability of a charging point. In yet another embodiment, the set of parameters may include a third optimization parameter associated with a waiting time at a charging point for charging the first vehicle 108A. In an embodiment, each optimization parameter of the set of optimization parameters may be associated with a set of constraints.

In an embodiment, the processor 202 may be configured to provide the set of optimization parameters as an option for selection by the user 316. The processor 202 may be configured to receive the user input to select the at least one optimization parameter among the set of optimization parameters. The user input may correspond to, but is not limited to, a touch input, a tactile input, an audio input, or a gesture. In an embodiment, the at least one optimization parameter among the set of optimization parameters may be displayed on a display screen associated with the infotainment system or the user device 314 (such as a mobile phone). In another example, the user 316 may be notified by using an audio signal, thereby rendering the at least one optimization parameter of the set of optimization parameters via a set of speakers associated with the infotainment system or the user device 314.

In an embodiment, the user input may be associated with the selection of the first optimization parameter. In an exemplary embodiment, the user 316 of the first vehicle 108A may select the first optimization parameter to minimize delay in the navigation from the first location to the second location. In another example embodiment, the user 316 of the first vehicle 108A may select the second optimization parameter to optimize certainty of a charging point that is available for charging the first vehicle 108A. In yet another exemplary embodiment, the user 316 of the first vehicle 108A may select the third optimization parameter to maximize a charging duration at a charging point for the first vehicle 108A.

At 404, an objective function generation operation may be executed. In the objective function generation operation, the apparatus 102 may be configured to generate the objective function based on the received user input. The generated objective function may be associated with the selected optimization parameter.

In an embodiment, based on the selection of the first optimization parameter, the apparatus 102 is configured to generate an objective function. The generated objective function may correspond to the minimization of the delay in the navigation towards the second location. Specifically, the objective function minimizes the delay time with respect to the anticipated arrival time at the second location. In an embodiment, the generated objective function may be subjected to a set of constraints. The set of constraints may include, but are not limited to, a charging point distance constraint and an exit constraint (similar to the charging point distant constraint and the exit constraint, as discussed with respect to FIG. 3). In an embodiment, the set of constraints may further include a maximum charging duration constraint. The maximum charging duration constraint may be associated with a charging duration of the first vehicle 108A at a charging point. In an embodiment, the maximum charging duration constraint may correspond to a limitation on the charging duration of the first vehicle 108A at the charging point. In an embodiment, to satisfy the maximum charging duration constraint, the charging duration of the first vehicle 108A must be greater than 10 minutes, 15 minutes, or the like.

In an embodiment, based on the selection of the second optimization parameter, the apparatus 102 is configured to generate an objective function. The generated objective function may correspond to optimizing certainty of a charging point that is available for charging the first vehicle 108A. Specifically, the objective function optimizes certainty of a charging point that is available for charging the first vehicle 108A. In an embodiment, the generated objective function may be subjected to a set of constraints. The set of constraints may include, but are not limited to, the maximum charging duration constraint, the charging point distance constraint, and the exit constraint.

In another embodiment, based on the selection of a third optimization parameter associated with the waiting time for charging the first vehicle 108A at a charging point, the apparatus 102 may be configured to generate an objective function. The objective function may correspond to the maximization of the charging duration at the charging point for the first vehicle 108A. Specifically, the objective function maximizes the charging duration at the charging point for the first vehicle 108A. In an embodiment, the generated objective function may be subjected to a set of constraints. The set of constraints may include, but are not limited to, the charging point distance constraint, the exit constraint, and an elapsed time constraint (similar to the elapsed time constraint, as discussed with respect to FIG. 3).

At 406, a solution computation operation may be executed. In the solution computation operation, the apparatus 102 may be configured to compute solution of the objective function. Specifically, the optimization module 202C of the processor 202 may be configured to compute a solution of the objective function using the optimization model 104. The optimization model 104 may employ at least one of the integer programming or the linear programming to compute the second solution of the second objective function. Details about the linear programming and the integer programming are provided, for example, in FIGS. 1, 2, and 3. In an embodiment, the solution of the objective function corresponds to the minimization of the delay in the navigation from the first location to the second location, optimizing certainty of a charging point that is available for charging the first vehicle 108A, or maximization of a charging duration at a charging point for the first vehicle 108A.

At 408, a recommendation generation operation may be executed. In the recommendation generation operation, the apparatus 102 may be configured to generate a recommendation for charging the first vehicle 108A. In an embodiment, the apparatus 102 may be configured to generate the recommendation based on the solution of the objective function. In an embodiment, the recommendation may include, but are not limited to, an amount of delay for charging the first vehicle 108A at a charging point, the location of the charging point, a distance of the charging point from the current location of the first vehicle 108A, a duration for charging the first vehicle 108A at the charging point, an initial charging time, a charging completion time, a probability of availability of the charging point, a route to reach the charging point, a charging cost to charge the first vehicle 108A at the charging point, routing instructions for the route, a time for starting a trip from the current location of the first vehicle 108A to the charging point, a speed of the first vehicle 108A for reaching the charging point, etc. By way of an example, the recommendation may indicate “charge the vehicle at the charging point for 30 minutes with a delay of 15 minutes in reaching your destination.” By way of another example, the recommendation may indicate “this charging point among nearby charging points has the highest likelihood of being available for charging.” By way of another example the recommendation may indicate “leave the traffic in 8 minutes for charging the vehicle at this charging point to get 30 minutes of charging.”

In an embodiment, the third ML model 206C may be configured to determine a performance score based on a real outcome of an event in which the recommendation was provided to the user 316 of the first vehicle 108A. Data indicating the real outcome may indicate, for example, a duration for which the first vehicle 108A was charged at a charging station, the availability of a charging station when the first vehicle 108A arrived at the charging station, the amount of delay for the first vehicle 108A to travel from the first location to the second location and charge at the charging station, etc. By way of example, if data indicating the real outcome indicate that: (1) a charging station was available for charging when the first vehicle 108A arrived at the charging station; (2) the first vehicle 108A was charged at a charging station for the duration as indicated in the recommendation; and (3) the delay for the first vehicle 108A to travel from the first location to the second location and charge at the charging station was equal to or less than the amount of delay as indicated in the recommendation, the third ML model 206C may output a high performance score, and apparatus 102 may continue to generate recommendations for users without any fine tuning. Conversely, if data indicating the real outcome indicate that: (1) a charging station was not available for charging when the first vehicle 108A arrived at the charging station; (2) the first vehicle 108A was not charged at a charging station for the duration as indicated in the recommendation; or (3) the delay for the first vehicle 108A to travel from the first location to the second location and charge at the charging station was greater than the amount of delay as indicated in the recommendation, the third ML model 206C may output a low performance score, and the apparatus 102 may fine tune processes for outputting recommendations for users (e.g., by altering one or more of the set of constraints, altering algorithm or programming used for generating recommendations, providing suggestions for altering the one or more of the set of constraints and/or the algorithm or programming used for generating recommendations to the users, etc.).

At 410, a recommendation output operation may be executed. In the recommendation output operation, the apparatus 102 may be configured to output the recommendation. Specifically, the output module 202D of the processor 202 may be configured to output the recommendation. In an embodiment, the output of the recommendation may correspond to the rendering of the recommendation on the user interface of the first vehicle 108A or a user device 314 associated with the user 316 of the first vehicle 108A.

In an embodiment, the fourth ML model 206D may be configured to determine a set of acceptance probabilities for each generated recommendation for charging the first vehicle 108A. The acceptance probability corresponds to the probability of selection of a respective recommendation by the user 316 of the first vehicle 108A. The acceptance probability may indicate whether the user 316 of the first vehicle 108A will select the respective recommendation or not. In an embodiment, based on the set of acceptance probabilities, the apparatus 102 may be configured to determine the recommendation with highest acceptance probability among the set of acceptance probabilities that the user 316 of the first vehicle may select for charging the first vehicle 108A. In an example embodiment, the fourth ML model 206D may be configured to cause the apparatus 102 to output the recommendation on the user device 314 associated with the first vehicle 108A.

In an embodiment, the fourth ML model 206D may be trained based on a set of historical datasets. The set of historical dataset may include, but are not limited to, historical information associated with at least one of a spatial identifier associated with the road segment 114 (such as a map tile id associated with the road segment 114, a city, a country) the functional class of the road segment 114 (such as the functional class 1, the functional class 2, and the like), event data, mobility graph data, a type of the objective function, a number of selection of the first recommendation by the user 316 of the first vehicle 108A. The event data may indicate one of a weekday (such as Monday, Wednesday, Friday) or weekend (Sunday). The type of the objective function may correspond to at least one of the objective function that corresponds to the maximization the charging duration for charging the first vehicle 108A, the objective function that corresponds to the minimization of the delay time with respect to the second location, etc. The mobility graph data may be indicative of a mobility graph pattern associated with the first vehicle 108A. In an embodiment, the mobility graph pattern may be indicative of the navigation of the first vehicle 108A. The mobility graph pattern may include, but are not limited to, an origin location of the first vehicle 108A, a destination location of the first vehicle 108A, frequent traversed paths to reach the destination location (such as the road segment 114), stopover points (such as the first charging point 120A of the set of charging points, rest areas), a preferred travel time to travel between the origin location of the first vehicle 108A and the destination of the first vehicle 108A.

FIG. 5 is a block diagram 500 that illustrates training of the first ML model 206A for prediction of the traffic congestion status on a road segment, in accordance with an embodiment of the disclosure. FIG. 5 is explained in conjunction with elements from FIGS. 1, 2, 3, and 4. With reference to FIG. 5, there is shown the block diagram 500 of the apparatus 102 that includes the first ML model 206A. There is further shown training dataset 502A, and traffic congestion status 504A.

In an embodiment, the apparatus 102 may be configured to train the first ML model 206A. The first ML model 206A may be trained on the training dataset 502A. The training dataset 502A may include a plurality of training samples and may correspond to a collection of examples that may be used to train the first ML model 206A to make accurate predictions or classifications. The training of the first ML model 206A may be an essential component in a machine learning process as it helps the first ML model 206A to learn patterns and relationships within input features (i.e., the set of features).

In an embodiment, the apparatus 102 may be configured to receive a first training sample of the plurality of training samples. The first training sample may be indicative of data associated with historical data on the traffic congestion, and the predicted traffic congestion status. The apparatus 102 may be configured to train the first ML model 206A using the training dataset 502A to output the traffic congestion status in real-life scenarios. In an embodiment, the training of the first ML model 206A may cause the first ML model 206A to generate output as a function of the set of attributes. The apparatus 102 may be further configured to determine the traffic congestion status based at least in part on the output of the first ML model 206A.

In another embodiment, the apparatus 102 may be configured to generate a new training sample to be included in the training dataset 502A. The new training sample may include the determined traffic congestion status, the determined first recommendation, the second recommendation, and the third recommendation. The apparatus 102 may be further configured to re-train the first ML model 206A using the generated new training sample. Therefore, the first ML model 206A may be re-trained even when the first ML model 206A is deployed in real-life scenarios.

FIG. 6 is a block diagram 600 that illustrates an exemplary third set of operations for recommendation plan of strategies for charging electric vehicles, in accordance with an embodiment of the disclosure. FIG. 6 is explained in conjunction with elements from FIG. 1 and FIG. 2. With reference to FIG. 6, there is shown the block diagram 600 that illustrates exemplary operations from 602 to 614, as described herein. The exemplary operations illustrated in the block diagram 600 may start at 602A and may be performed by any computing system, apparatus, or device, such as by the apparatus 102 of FIG. 1 or the processor 202 of FIG. 2. Although illustrated with discrete blocks, the exemplary operations associated with one or more blocks of the block diagram 600 may be divided into additional blocks, combined into fewer blocks, or eliminated, depending on the implementation.

In an embodiment, the user 316 of the first vehicle 108A may be planning to navigate from a route from a first location (e.g., the user's starting location) to the second location (e.g., the user's destination) using the first vehicle 108A. The exemplary operations from 602 to 602 may be executed as soon as an ignition of the first vehicle 108A may be turned on or the first vehicle 108A starts moving. In another embodiment, the exemplary operations from 602 to 602 may be executed based on a reception of the user input from the user 316 of the first vehicle 108A via an input device (say via a button installed in the first vehicle 108A). In another embodiment, the exemplary operations from 602-602 may be executed based on the environment of the first vehicle 108A or the state of the first vehicle 108A. For example, the exemplary operations from 302-302 may be executed if the first vehicle 108A slows down in a highway, the first vehicle 108A drives below a predetermined speed at a highway, the first vehicle 108A enters an area with a predetermined amount of traffic congestion, or a combination thereof.

At 602, a route acquisition operation may be executed. In the route acquisition operation, the apparatus 102 may be configured to obtain the route to the destination of the first vehicle 108A (such as the second location). Specifically, the input module 202A of the processor 202 may be configured to obtain the route to the destination of the first vehicle 108A. In an embodiment, the apparatus 102 may be configured to obtain the route to the destination of the first vehicle 108A based on the reception of the user input. In another embodiment, the apparatus 102 may be configured to obtain route to the destination of the first vehicle 108A automatically without reception of any user input based on the mobility pattern of the user 316 associated with the first vehicle 108A. In yet another embodiment, the apparatus 102 may be configured to obtain the route to the destination of the first vehicle 108A from the map database 110B.

At 604, a parameters acquisition operation may be executed. In the parameters acquisition operation, the apparatus 102 may be configured to obtain a set of parameters including road segment parameters. The road segment parameters may be indicative of the one or more road attributes associated with the road segment 114 and may include, but are not limited to, a width of the road segment 114, a length of the road segment 114, an elevation of the road segment 114, a number of lane segments associated with the road segment 114, and a width of the lane segments. In an embodiment, the elevation of the road segment 114 may correspond to a height of the road segment 114 with respect to a reference point (such as the sea level). In an embodiment, a width of the lane segment may correspond to a maximum horizontal distance between a first edge of the road segment 114 and a second edge of the road segment 114.

In another embodiment, the set of parameters may further include an initial battery level of the first vehicle 108A, a battery capacity of the first vehicle 108A, an electric power associated with the first vehicle 108A, a distance between the first location and the second location, congestion information, a functional class of the road segment 114, a temperature around the first vehicle 108A, a humidity level around the first vehicle 108A, and event data.

In an example embodiment, the initial battery level of the first vehicle may correspond to a current battery level of the first vehicle 108A and may be, for example, 40%, 60%, and the like. In an embodiment, the battery capacity of the first vehicle 108A may correspond to a measure of the total amount of electrical energy a battery may store, typically expressed in ampere-hours (Ah) or watt-hours (Wh). The battery capacity of the first vehicle 108A may represent the maximum amount of charge that can be extracted from a fully charged battery under specified conditions.

In an example embodiment, the electric power associated with the first vehicle 108A may refer to the rate at which electrical energy may transferred from the battery to the electric motor and other electrical systems associated with the first vehicle 108A. In an embodiment, the congestion information may indicate traffic congestion of a location (e.g., the road segment 114). The traffic congestion may be quantified in an amount of time as a delay from an estimated time of arrival (ETA) at a destination (e.g., the second location). The event data may be indicative of, but is not limited to, time of day, national holidays (such as the Christmas, the New Year, and the like), a day before the holiday, a day after the holiday, etc. Additionally, or alternatively, the event data may indicate whether it is a holiday or not. Further, the event data may further indicate whether the current day is a weekday or a weekend.

In an embodiment, apparatus 102 may be configured to obtain the set of parameters based on the reception of the user input or the start of the ignition of the first vehicle 108A. In another embodiment, the apparatus 102 may be configured to obtain the set of parameters automatically without reception of any user input. In yet another embodiment, the apparatus 102 may be configured to obtain the set of parameters from the map database 110B.

At 606, a second ML model application operation may be executed. In the second ML model application operation, the apparatus 102 may be configured to cause the second ML model 206B to output the prediction indicative of the first vehicle 108A traversing the route to reach the destination as a function of the set of parameters. Specifically, the ML application module 202B of the processor 202 may be configured to cause the second ML model 206B to output the prediction indicative of the first vehicle 108A traversing the route to reach the destination as a function of the set of parameters.

In an embodiment, the second ML model 206B is trained to predict whether the first vehicle 108A will reach the second location with a current battery level associated with the first vehicle 108A. In an embodiment, the second ML model 206B corresponds to a classification model. Based on the set of parameters, the classification model is configured to associate the first vehicle 108A with a class label. In an embodiment, the class label corresponds to a first label indicative of the first vehicle 108A reaching the second location with the current battery level associated with the first vehicle 108A. In another embodiment, the class label corresponds to a second label indicative of an inability of the first vehicle 108A to reach the second location. In an embodiment, the second ML model 206B may be trained on historical data associated with the set of parameters.

At 608, a determination is made whether the predicted driving range of the first vehicle 108A is less than the first driving range of the first vehicle 108A or not. In an embodiment, the first driving range of the first vehicle 108A may correspond to a distance between the current location of the first vehicle 108A and the destination of the first vehicle 108A. If the predicted driving range of the first vehicle 108A is less than the first driving range of the first vehicle 108A, the operation may continue at 612 based on the predicted driving range. Otherwise, the operation terminates at 610.

At 612, a recommendation generation operation may be executed. In the recommendation generation operation, the apparatus 102 may be configured to generate a recommendation for charging the first vehicle 108A based on the prediction. The recommendation may include, but is not limited to, a modification in the speed of the first vehicle 108A, a modification in one or more parameters of the onboard systems associated with the first vehicle 108A, or a combination thereof. By way of an example and not limitation, the fourth recommendation may correspond to “You are not going to make it to the second location, please change speed of the vehicle to 30 miles to reduce battery consumption”. By way of another example and not limitation, the recommendation may correspond to “You are not going to make it to the second location, please turn off the heating system to reduce battery consumption.” In an embodiment, the recommendation generated in the recommendation generation operation at 612 may be similar to the recommendation generated via the operations performed in 306, 308, and 310 of FIG. 3 or the operations performed in 404, 406, and 408 of FIG. 4.

At 614, a recommendation output operation may be executed. In the recommendation output operation, the apparatus 102 may be configured to output the recommendation. In an embodiment, the apparatus 102 may cause the recommendation to be output on the user interface of the first vehicle 108A or the user device 314 associated with the user 316 of the first vehicle 108A. Details about the recommendation output operation are provided, for example, in FIG. 3and FIG. 4.

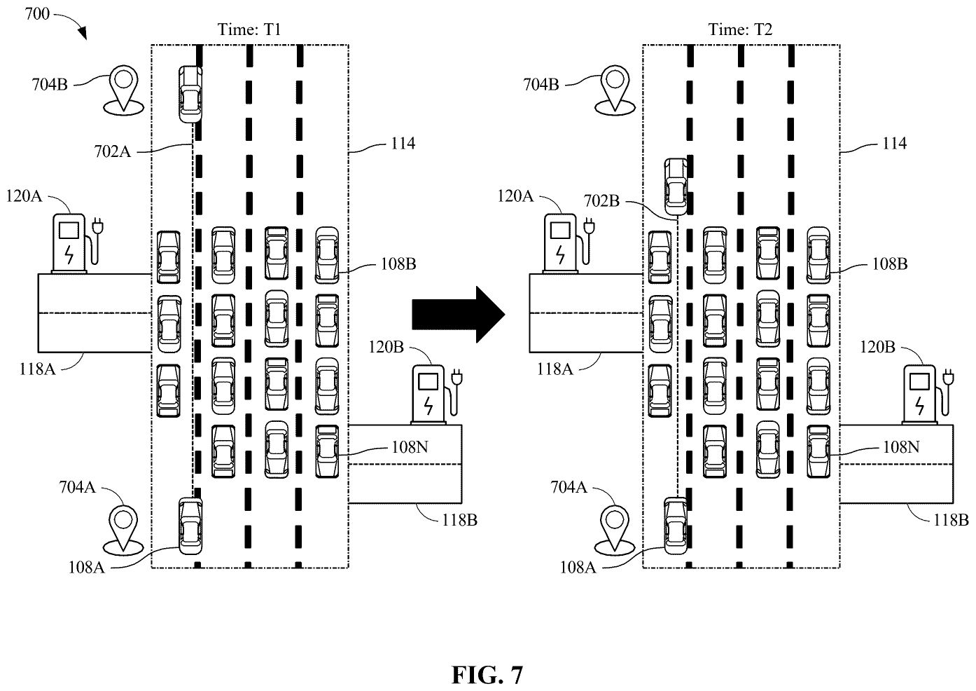

FIG. 7 is a diagram that depicts an exemplary scenario 700 for determining reduced driving range of electric vehicles, in accordance with an embodiment of the disclosure. FIG. 7 are explained in conjunction with elements from FIGS. 1, 2, 3, 4, 5, and 6. With reference to FIG. 7, there is shown there is shown the exemplary scenario 700 that includes the first vehicle 108A and the set of vehicles 108 travelling on the road segment 114. With reference to FIG. 7, there is further shown an actual range 702A of the first vehicle 108A from a source 704A of the first vehicle 108A to a destination 704B of the first vehicle 108A. FIG. 7 may represent a scenario at a time “T1”. With reference to FIG. 7, there is further shown a reduced driving range 702B of the first vehicle 108A with respect to the destination 704B of the first vehicle 108A. FIG. 7 may further represent a scenario at a time “T2” after time “T1”.

At time “T1”, the apparatus 102 may be configured to obtain a route to the destination 704B of the first vehicle 108A. In an embodiment, the apparatus 102 may be configured to obtain route information associated with the route to the destination 704B of the first vehicle 108A. The route information may be indicative of one or more road segments of the route to be traversed by the first vehicle 108A to reach the destination 704B of the first vehicle 108A. The apparatus 102 may be configured to obtain the set of parameters including road segment parameters indicative of one or more road attributes associated with the one or more road segments of the route.

In an embodiment, the road segment parameters may be indicative of one or more road attributes associated the road segment 114 of the route. The one or more road attributes associated with the road segment 114 may include, but are not limited to, a width of the road segment 114, the length of the road segment 114, the elevation of the road segment 114, the number of lane segments associated with the road segment 114, and the width of the lane segments. In another embodiment, the set of parameters may further include an initial battery level of the first vehicle 108A, a battery capacity of the first vehicle 108A, an electric power associated with the first vehicle 108A, a distance between the first location and the second location, congestion information, a functional class of the road segment 114, a temperature around the first vehicle 108A, a humidity level around the first vehicle 108A, and event data. Details about the one or more road segment attributes are provided, for example, in FIG. 6.

The apparatus 102 may be configured to cause the second ML model 206B to output a prediction indicative of the first vehicle 108A traversing the route to reach the destination 704B as a function of the set of parameters. Details about the second ML model 206B are provided, for example, in FIG. 6. Based on the prediction, the apparatus 102 may be configured to determine the recommendation for charging the first vehicle 108A. In an embodiment, the prediction may be indicative of the reduced driving range 702B of the first vehicle 108A with respect to the destination 704B of the first vehicle 108A at time “T2”. The apparatus 102 may be configured to generate the recommendation in response to the determined reduced driving range 702B of the first vehicle 108A being less than the actual range 702A of the first vehicle 108A. The recommendation may include, but are not limited to, a modification in a speed of the first vehicle 108A, a modification in one or more parameters of the on-board systems associated with the first vehicle 108A, or a combination thereof. By way of an example and not limitation, the fourth recommendation may be “You are not going to make it to the destination, please change speed of the vehicle to 30 miles to reduce battery consumption.” In an embodiment, the recommendation generated with respect to FIG. 7 may be similar to the recommendation generated via the operations performed in 306, 308, and 310 of FIG. 3 or the operations performed in 404, 406, and 408 of FIG. 4.

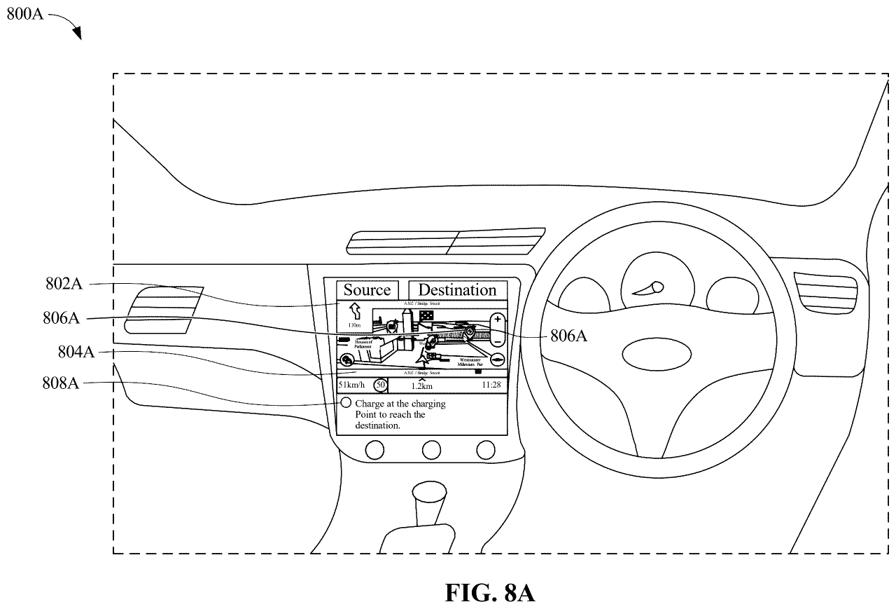

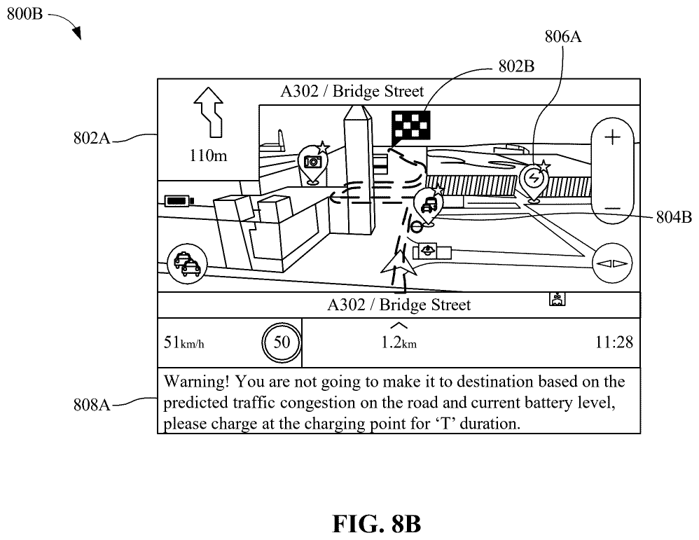

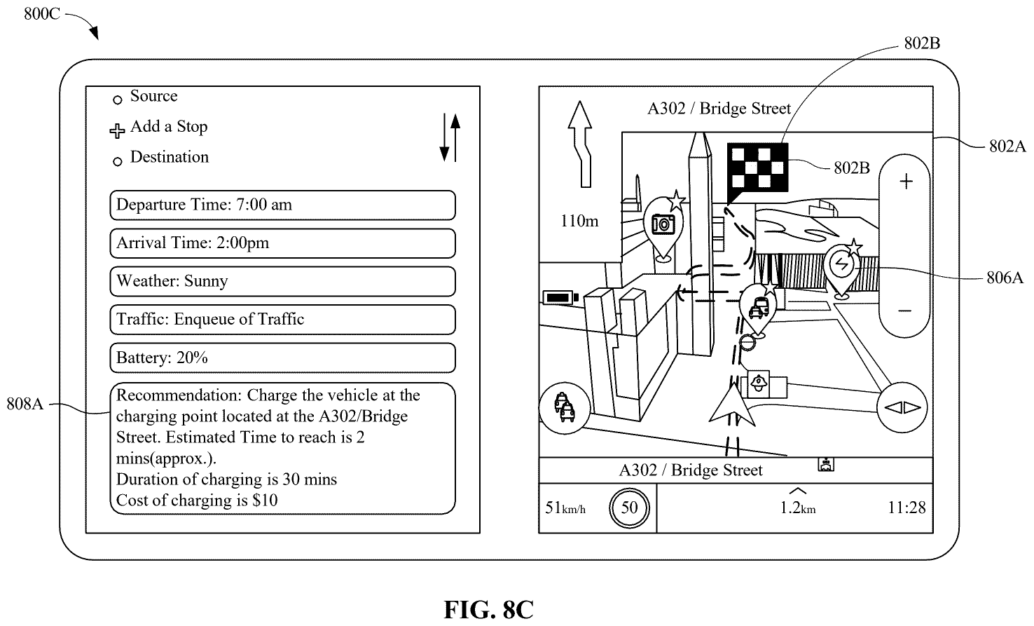

FIG. 8A is a diagram that illustrates a first exemplary scenario of rendering recommendations on a user interface, in accordance with an embodiment of the disclosure. FIG. 8A is explained in conjunction with elements from FIGS. 1, 2, 3, 4, 5, 6.and 7. With reference to FIG. 8A, there is shown the exemplary scenario 800A that includes an interior cabin of the first vehicle 108A. There is further shown, a display screen 802A of an infotainment system.

In an embodiment, the apparatus 102 may be configured to generate the recommendation for charging the first vehicle 108A. The apparatus 102 may be configured to obtain the traffic congestion information on the road segment 114. Based on the traffic congestion information, the apparatus 102 may be configured to predict the traffic congestion status. The apparatus 102 may be configured to generate the recommendation in response to the traffic congestion status indicative of the traffic at the road segment 114. For example, a map 804A may be displayed on the display screen 802A. The map 804A may indicate a charging point 806A that may be recommended to the user 316 of the first vehicle 108A for charging the first vehicle 108A. The apparatus 102 may be configured to render a recommendation 808A on the display screen 802A for the user 316 of the first vehicle 108A. By way of an example and not limitation, the recommendation 808A may correspond to “Charge at the charging point to reach the destination.”

FIG. 8B is a diagram that illustrates a second exemplary scenario for depicting rendering recommendations on a user interface, in accordance with an embodiment of the disclosure. FIG. 8B is explained in conjunction with elements from FIGS. 1, 2, 3, 4, 5, 6, 7, and 8A. With reference to FIG. 8B, there is shown the exemplary scenario 800B that includes the display screen 802A of the infotainment system. For example, as shown in the FIG. 8B, there is displayed a map depicting a route 804B to be traversed by the first vehicle 108A to a destination 802B of the first vehicle 108A, a charging point 806A, and a recommendation 808A. By way of an example, the recommendation 808A may indicate “WARNING! You are not going to make it to the destination based on the predicted traffic congestion on the road and current battery level, please charge at the charging point for ‘T’ duration.”

FIG. 8C is a diagram that illustrates a third exemplary scenario for depicting rendering recommendations on a user interface, in accordance with an embodiment of the disclosure. FIG. 8C is explained in conjunction with elements from FIGS. 1, 2, 3, 4, 5, 6, 7, 8A, and 8B. With reference to FIG. 8C, there is shown the exemplary scenario 800C that includes the display screen 802A of an infotainment system.

For example, as shown in the FIG. 8C there is displayed a map depicting a route to the destination 802B of the first vehicle 108A. The display screen 802A may indicate first temporal information associated with a departure time (such as 7:00 am) from the current location of the first vehicle 108A, second temporal information associated with an estimated arrival time (such as 2:00 pm) at the destination 802B, weather information associated with the environment around the first vehicle 108A (such as, sunny), traffic information associated with the route traversed by the first vehicle 108A (such as congested), and battery information associated with the battery level of the first vehicle 108A (such as 20%).

Based on the prediction indicating that the predicted driving range of the first vehicle 108A is less than the first driving range, the apparatus 102 may be configured to generate the recommendation 808A. By way of an example and not limitation, the recommendation 808A may correspond to “Charge the vehicle at the charging point located at the A303/Bridge Street. Estimated time to reach is 2 mins (approx.). Duration of charging is 30 minutes. Cost of charging is $10.” In an embodiment, based on the generated recommendation 808A, the apparatus 102 may be configured to cause the first vehicle 108A to navigate to the destination 802B after the completion of the charging of the first vehicle 108A. In an embodiment, the apparatus 102 may be configured to cause the first vehicle 108A to control the at least one vehicle-related function (such as a speed control function, electrical equipment usage, and the like) that may impact the consumption of the battery. In an example embodiment, the apparatus 102 may be configured to activate the cruise control functionality of the first vehicle 108A such that the first vehicle 108A cruises at a constant speed. This may increase the battery life and the driving range of the first vehicle 108A. In another embodiment, the apparatus 102 may turn off the air conditioning system installed in the first vehicle 108A to reduce a rate of drain of the battery of the first vehicle 108A. This may increase the driving range of the first vehicle 108A.

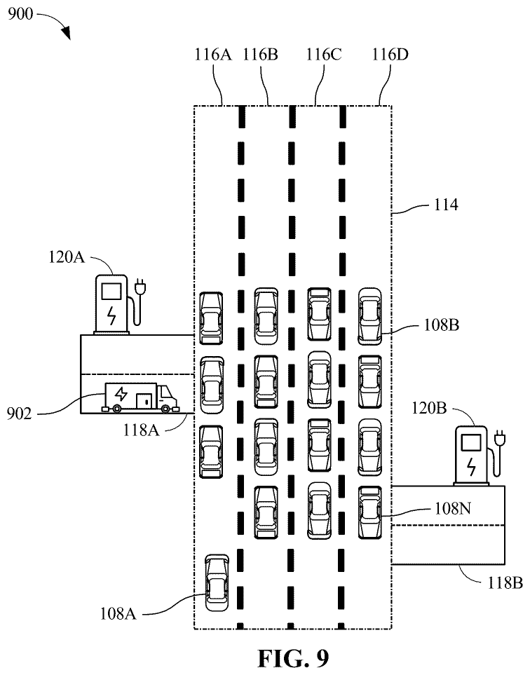

FIG. 9 is a diagram that depicts an exemplary scenario 900 for charging electric vehicle with electric vehicle charging unit (EVCU) 902, in accordance with an embodiment of the disclosure. With reference to FIG. 9, there is shown the exemplary scenario 900 that includes the first vehicle 108A and the set of vehicles 108 travelling on the road segment 114. In an embodiment, the apparatus 102 may be configured to determine a need for the EVCU 902 at a location proximate to the road segment 114 (such as the first lane segment 116A). In an embodiment, the apparatus 102 may be configured to obtain the traffic congestion information associated with the road segment 114 (such as a type of incident associated with the road segment 114, the number of the vehicles on the road segment 114, an average speed of the vehicles on the road segment 114), one or more geographical attributes of the location (a type of a road surface associated with the location, point of interests associated with the location for charging the first vehicle 108A, and the like), one or more weather condition associated with the location (such as snow, rain, mist, and the like), historical information associated with the traffic congestion information, or a combination thereof. In an example embodiment, the point of interests associated with the location may correspond to where the EVCP may reach the first vehicle 108A to charge the first vehicle 108A, for example, an edge of the location. In an embodiment, the type of incidents associated with the road segment 114 may include, but are not limited to, head-on collisions between at least two vehicles, rear-end collisions between at least two vehicles, side-impact collisions between at least two vehicles, and a collision of at least one vehicle with an object on the road segment 114.

Based on a combination of the traffic congestion information on the road segment 114, one or more geographical attributes of the location, one or more weather condition associated with the location, and historical information associated with the traffic congestion information, the apparatus 102 may be configured to determine the need for the EVCU at the location proximate to the road segment 114.

In an embodiment, the apparatus 102 may be configured to transmit a request for the EVCU 902 at the location in response to a battery level of the first vehicle 108A being less than a threshold battery level (e.g., 50%, 40%, 30%, or the like). Based on the transmitted request, the apparatus 102 may be configured to generate a request for or control the EVCU 902 to navigate to the location proximate to the road segment 114 on which the first vehicle 108A may be traversing to reach the intended destination, thereby enabling the user of the first vehicle 108A to use the EVCU 902 to charge the first vehicle 108A. In an embodiment, the EVCU 902 may provide a designated amount of charge to the first vehicle 108A, thereby ensuring that the first vehicle 108A is capable of reaching its intended destination.

In an embodiment, the EVCU 902 may be equipped with a power supply configured to charge one or more electric vehicles. In an embodiment, the EVCU 902 may be a device that may supply electrical power for recharging the one or more electric vehicles. The EVCU 902 may include at least one of a charging port, a cabinet, a controller process control block (PCB), a charging cable, connector pins, or the like. The charging port may be a physical port that may be plugged in the first vehicle 108A to charge the first vehicle 108A. The cabinet may include internal components of the EVCU 902 to provide protection. The controller PCB may be a circuit board that may control charging process. The charging cable and the connector pins may be configured to connect the EVCU 902 to the first vehicle 108A.

In an embodiment, the EVCU 902 may be a vehicle. The vehicle may include, but are not limited to, a two-wheeler vehicle, a three-wheeler vehicle, a four-wheeler vehicle, more than four-wheeler vehicle, a hybrid vehicle, or a vehicle with autonomous drive capability that uses one or more distinct renewable or non-renewable power sources (such as a van, a truck a trailer, or the like). The vehicle may include a plurality of charging points and a power source to charge one or more electric vehicles via the plurality of charging points.

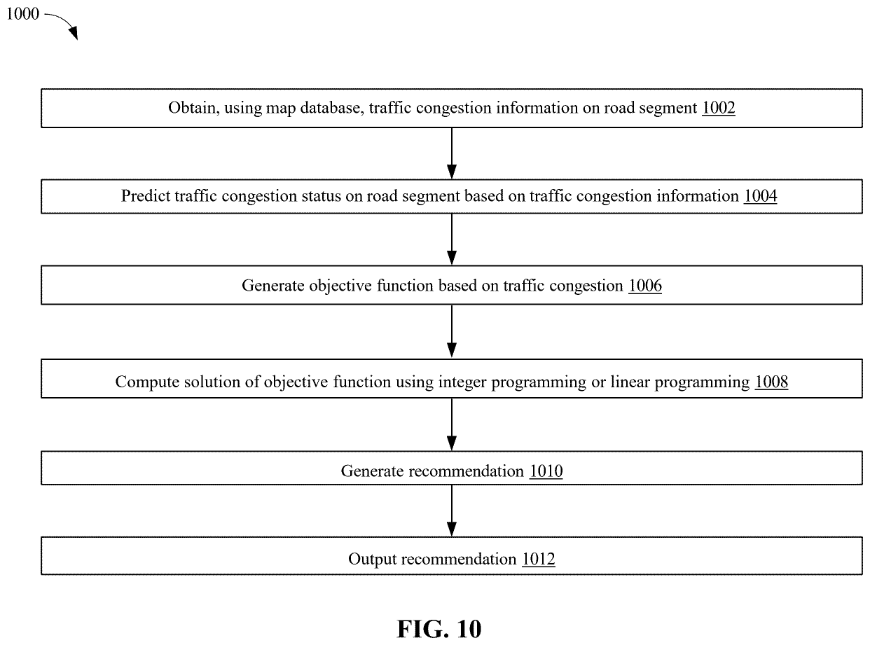

FIG. 10 is a flowchart 1000 that illustrates a first exemplary method of providing a recommendation for charging an electric vehicle, in accordance with an embodiment of the disclosure. FIG. 10 is explained in conjunction with elements from FIGS. 1, 2, 3, 4A, 4B, 5, 6, 7, 8 and 9. With reference to FIG. 10, there is shown the flowchart 1000. The operations of the first exemplary method may be executed by any computing system, for example, by the apparatus 102 of FIG. 1 or the processor 202 of FIG. 2. The operations of the flowchart 1000 may start at 1002.

At 1002, the traffic congestion information on the road segment 114 may be obtained from the mapping database 110B. In an embodiment, the apparatus 102 may be configured to obtain the traffic congestion information on the road segment 114 from the mapping database 110B. In at least one embodiment, the processor 202 may be configured to obtain the traffic congestion information on the road segment 114.

At 1004, the traffic congestion status on the road segment 114 may be predicted based on the traffic congestion information. In at least one embodiment, the processor 202 may be configured to predict the traffic congestion status on the road segment 114 based on the traffic congestion information.

At 1006, the objective function may be generated based on the traffic congestion. In an embodiment, apparatus 102 may be configured to generate an objective function if the traffic congestion status indicates that the traffic congestion on the road segment 114 is dequeuing or stagnant. In an embodiment, apparatus 102 may be configured to generate an objective function if the traffic congestion status indicates that the traffic congestion on the road segment 114 is predicted dequeue, remain stagnant for a period, or a combination thereof. In an embodiment, the objective function may correspond to maximization in a duration for charging the first vehicle 108A at a charging point, minimization of a delay in navigation from a first location (e.g., starting location of a user of the first vehicle 108A) to the second location (e.g., the user's destination), or optimizing certainty of a charging point that is available for charging the first vehicle 108A. In an embodiment, the objective function may be subjected to a set of constraints. The set of constraints may correspond to limitations associated with decision variables of the objective function. The set of constraints may include at least one of a travel time constraint, a charging point distance constraint, a charging point availability constraint, an elapsed time constraint, a delay time constraint, and an exit constraint.

At 1008, a solution of the objective function may be computed by using integer programming or linear programming. Specifically, the optimization module 202C of the processor 202 may be configured to compute the solution of the objective function using the optimization model 104. The optimization model 104 may employ at least one of the integer programming or the linear programming to compute the solution of the objective function.

At 1010, a recommendation may be generated. In an embodiment, the recommendation may include, but are not limited to, a location of a charging point, a distance of the charging point from the current location of the first vehicle 108A, a duration for charging the first vehicle 108A at the charging point, an initial charging time and a charging completion time, an amount of delay for charging the first vehicle 108A at the charging point, a probability of availability of the charging point, a route to reach the charging point, a charging cost to charge the first vehicle 108A at the charging point, routing instructions for the route, a time for starting a trip from the current location of the first vehicle 108A to the charging point, a speed of the first vehicle 108A for reaching the charging point, etc.

At 1008, the recommendation may be output. In at least one embodiment, the processor 202 may be configured to output the recommendation. The processor 202 may be configured to output the recommendation on a user interface of the first vehicle 108A or a user device associated with the user of the first vehicle 108A.

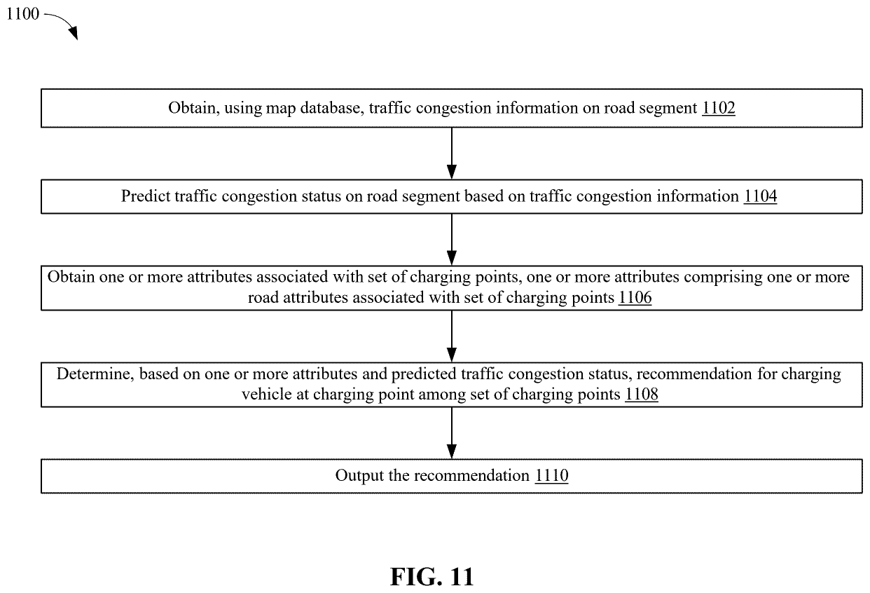

FIG. 11 is a flowchart 1100 that illustrates a second exemplary method of providing a recommendation for charging an electric vehicle, in accordance with an embodiment of the disclosure. FIG. 11 is explained in conjunction with elements from FIGS. 1, 2, 3, 4A, 4B, 5, 6,7, 8, 9 and 10. With reference to FIG. 11, there is shown the flowchart 1100. The operations of the second exemplary method may be executed by any computing system, for example, by the apparatus 102 of FIG. 1 or the processor 202 of FIG. 2. The operations of the flowchart 1100 may start at 1102.

At 1102, the traffic congestion information on the road segment 114 may be obtained from the mapping database 110B. In an embodiment, the apparatus 102 may be configured to obtain the traffic congestion information on the road segment 114 from the mapping database 110B. In at least one embodiment, the processor 202 may be configured to obtain the traffic congestion information on the road segment 114 from the mapping database 110B.

At 1104, the traffic congestion status on the road segment 114 may be predicted based on the traffic congestion information. In an embodiment, the apparatus 102 may be configured to predict the traffic congestion status based on the traffic congestion information. In at least one embodiment, the processor 202 may be configured to predict the traffic congestion status based on the traffic congestion information.

At 1106, the one or more attributes associated with the set of charging points may be obtained. The one or more attributes may include the one or more road attributes associated with the set of charging points. In an embodiment, the apparatus 102 may be configured to obtain the one or more attributes associated with the set of charging points. In at least one embodiment, the processor 202 may be configured to obtain the one or more attributes associated with the set of charging points.

At 1108, the recommendation for charging the first vehicle 108A at a charging point among the set of charging points may be generated based on the one or more road attributes and the predicted traffic congestion status. In an embodiment, the apparatus 102 may be configured to generate the recommendation for charging the vehicle at the first charging point 120A among the set of charging points based on the one or more attributes and the predicted traffic congestion status. In at least one embodiment, the processor 202 may be configured to generate the recommendation for charging the first vehicle 108A at the first charging point 120A among the set of charging points based on the one or more attributes and the predicted traffic congestion status.

At 1110, the recommendation may be output. In an embodiment, the apparatus 102 may be configured to output the recommendation. In at least one embodiment, the processor 202 may be configured to output the recommendation.

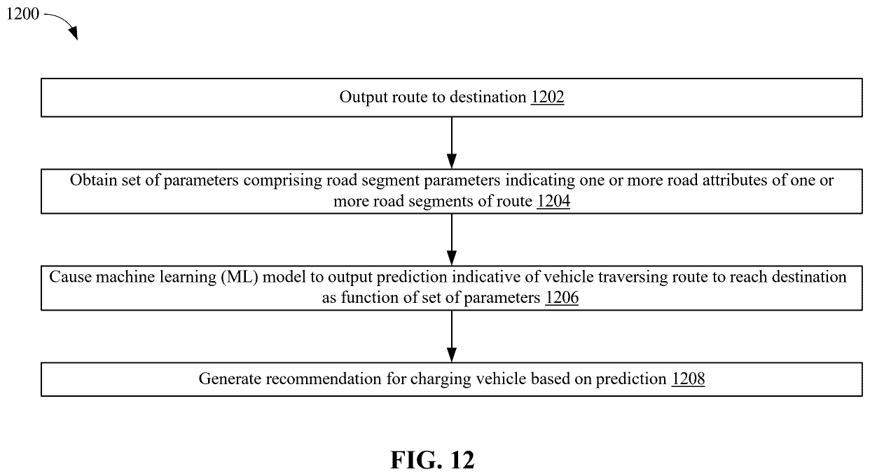

FIG. 12 is a flowchart 1200 that illustrates a third exemplary method for providing a recommendation for charging an electric vehicle, in accordance with an embodiment of the disclosure. FIG. 12 is explained in conjunction with elements from FIGS. 1, 2, 3, 4A, 4B, 5, 6, 7, 8, 9, 10, 11 and 12. With reference to FIG. 12, there is shown the flowchart 1200. The operations of the third exemplary method may be executed by any computing system, for example, by the apparatus 102 of FIG. 1 or the processor 202 of FIG. 2. The operations of the flowchart 1200 may start at 1202.

At 1202, the route to the destination may be obtained. In an embodiment, the apparatus 102 may be configured to obtain the route to the destination. In an embodiment, the processor 202 may be configured to obtain the route to the destination.

At 1204, the set of parameters including the road segment parameters indicating the one or more road attributes of the one or more road segments of the route may be obtained. In an embodiment, the apparatus 102 may be configured to obtain the set of parameters including the road segment parameters indicating the one or more road attributes of the one or more road segments of the route. In at least one embodiment, the processor 202 may be configured to obtain the set of parameters including the road segment parameters indicating the one or more road attributes of the one or more road segments of the route.

At 1206, the prediction indicative of the first vehicle 108A traversing the route to reach the destination as the function of the set of parameters may be outputted. In an embodiment, the apparatus 102 may be configured to cause the second ML model 206B to output the prediction indicative of the first vehicle 108A traversing the route to reach the destination as the function of the set of parameters. In at least one embodiment, the processor 202 may be configured to cause the second ML model 206B to output the prediction indicative of the first vehicle 108A traversing the route to reach the destination as the function of the set of parameters.

At 1208, the recommendation for charging the first vehicle 108A may be generated. In an embodiment, the apparatus 102 may be configured to generate the recommendation for charging the first vehicle 108A based on the prediction. In at least one embodiment, the processor 202 may be configured to generate the recommendation based on the prediction indicative of the first vehicle 108A traversing the route to reach the destination as the function of the set of parameters.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An apparatus comprising at least one processor and at least one non-transitory memory including computer program code instructions, the computer program code instructions configured to, when executed, cause the apparatus to:
obtain, using a map database, traffic congestion information on a road segment;
predict a traffic congestion status on the road segment based on the traffic congestion information;
generate an objective function based on the traffic congestion status;
compute a solution of the objective function using an integer programming or a linear programming;
generate a recommendation based on the solution; and
output the recommendation.

2. The apparatus of claim 1, wherein the objective function corresponds to maximization in a duration for charging the vehicle, and wherein the recommendation is associated with the duration.

3. The apparatus of claim 2, wherein the objective function is subjected to a set of constraints, and wherein the set of constraints comprises at least one of: a travel time constraint, a charging point distance constraint, a charging point availability constraint, and an elapsed time constraint.

4. The apparatus of claim 1, wherein the objective function is a first objective function, wherein the recommendation is a first recommendation, and wherein the computer program code instructions are configured to, when executed, cause the apparatus to:
receive a user input associated with a selection of an optimization parameter among a set of optimization parameters, wherein the set of optimization parameters comprises: a first optimization parameter associated with a delay in navigation towards a charging point, a second optimization parameter associated with an availability of the charging point, or a combination thereof;
generate a second objective function based on the user input, wherein the second objective function is associated with the optimization parameter;
generate a second recommendation for charging the vehicle based on a solution of the second objective function; and
output the second recommendation.

5. The apparatus of claim 4, wherein each optimization parameter of the set of optimization parameters is associated with a set of constraints, and wherein the set of constraints is associated with at least one of: a delay constraint and a charging point distance constraint.

6. The apparatus of claim 4, wherein the user input is associated with a selection of the first optimization parameter, and wherein the second objective function corresponds to a minimization of the delay in the navigation towards the charging point.

7. The apparatus of claim 4, wherein the user input is associated with a selection of the second optimization parameter, and wherein the second objective function corresponds to an assurance of the availability of the charging point.

8. The apparatus of claim 1, wherein the computer program code instructions are configured to, when executed, cause the apparatus to:
extract a set of features based on the road segment and the traffic congestion information;
apply a first machine learning (ML) model on the extracted set of features; and
predict the traffic congestion status on the road segment based on the application of the first ML model on the extracted set of features.

9. The apparatus of claim 8, wherein the set of features is associated with: a functional class of the road segment, a cause of traffic congestion on the road segment, a delay in an estimated time of arrival of the vehicle, a timestamp, or a combination thereof.

10. The apparatus of claim 1, wherein the traffic congestion status indicates a duration of a traffic congestion on the road segment.

11. The apparatus of claim 1, wherein the recommendation indicates a duration for charging the vehicle at a charging point.

12. The apparatus of claim 1, wherein the computer program code instructions are configured to, when executed, cause the apparatus to:
determine a need for an electric vehicle charging unit (EVCU) at a location proximate to the road segment based on the traffic congestion information, one or more geographical attributes of the location, one or more weather conditions associated with the location, or a combination thereof, wherein the EVCU is equipped with a power supply configured to charge the vehicle; and
responsive to the need satisfying a threshold, transmit a request for the EVCU at the location.

13. The apparatus of claim 1, wherein the computer program code instructions are configured to, when executed, cause the apparatus to:
(i) output the recommendation on a user interface associated with the vehicle;
(ii) based on the recommendation, causing the vehicle to control at least one vehicle-related function; or
(iii) a combination thereof.

14. A method comprising:
obtaining, using a map database, traffic congestion information on a road segment;
predicting a traffic congestion status on the road segment based on the traffic congestion information;
obtaining one or more attributes associated with a set of charging points, the one or more attributes comprising one or more road attributes associated with the set of charging points;
generating, based on the one or more attributes and the predicted traffic congestion status, a recommendation for charging a vehicle at a charging point among the set of charging points; and
outputting the recommendation.

15. The method of claim 14, wherein the recommendation comprises routing instructions to navigate towards the charging point.

16. The method of claim 14, wherein the generating comprises:
generating an objective function based on the one or more attributes and the traffic congestion status, wherein the objective function corresponds to a minimization of a waiting time at the charging point;
computing a solution of the objective function using an integer programming or a linear programming; and
generating the recommendation based on the solution.

17. The method of claim 16, wherein the one or more road attributes indicates one or more functional classes of one or more road segments associated with the set of charging points, wherein the objective function is subjected to at least one constraint, and wherein the at least one constraint is the one or more functional classes.

18. The method of claim 17, wherein the objective function is further subjected to a set of constraints, and wherein the set of constraints comprises at least one of: a charging point availability constraint, an elapsed time constraint, a power compatibility constraint, and a temperature constraint.

19. The method of claim 14, further comprising:
(i) outputting the recommendation on a user interface associated with the vehicle;
(ii) based on the recommendation, causing the vehicle to control at least one vehicle-related function; or
(iii) a combination thereof.

20. A non-transitory computer-readable storage medium having computer program code instructions stored therein, the computer program code instructions, when executed by at least one processor, cause the at least one processor to:
obtain a route to a destination;
obtain a set of parameters comprising road segment parameters indicating one or more road attributes of one or more road segments of the route;
cause a machine learning (ML) model to output a prediction indicative of a vehicle traversing the route to reach the destination as a function of the set of parameters; and
generate a recommendation for charging the vehicle based on the prediction.
